(19) United States
(12) Patent Application Publication
(10) Pub. No.: US 2025/0155884 A1
(43) Pub. Date: May 15, 2025

(54) METHOD AND DEVICE FOR IDENTIFYING GEOMETRIC ERROR OF NUMERICAL CONTROL (NC) MACHINE TOOL BASED ON MODIFIED 9-LINE METHOD

(71) Applicant: GUANGDONG OCEAN UNIVERSITY, Zhanjiang (CN)

(72) Inventors: Huanlao LIU, Zhanjiang (CN); Hengyu ZHOU, Zhanjiang (CN); Wenbin ZHANG, Zhanjiang (CN); Yulin WANG, Zhanjiang (CN)

(21) Appl. No.: 19/027,987

(22) Filed: Jan. 17, 2025

Related U.S. Application Data
(63) Continuation of application No. PCT/CN2024/116876, filed on Sep. 4, 2024.

(30) Foreign Application Priority Data
Dec. 5, 2023 (CN) 202311651145.3

(51) Int. Cl. G05B 23/02

(52) U.S. Cl. CPC G05B 23/0243

(57) ABSTRACT

A method and a device for identifying geometric errors of a numerical control (NC) machine tool based on a modified nine-line method. Motion errors between a plurality of rigid bodies of the NC machine tool is superimposed to construct a comprehensive error model based on multibody system kinematics theory and a topological structure of the NC machine tool. Optimization is performed based on the comprehensive error model and a preset fitness function to predict six optimal measurement positions. Six linear measurement trajectories are established respectively at the six optimal measurement positions. The six linear measurement trajectories are each parallel to one of an X-axis, a Y-axis, and a Z-axis. error terms for each of the six linear measurement trajectories are measured to establish a first equation set having six first equations. Geometric error simulation and identification for the NC machine tool are performed based on the first equation set.

### CROSS-REFERENCE TO RELATED APPLICATIONS

This application is a continuation of International Patent Application No. PCT/CN2024/116876, filed on Sep. 4, 2024, which claims the benefit of priority from Chinese Patent Application No. 202311651145.3, filed on Dec. 5, 2023. The content of the aforementioned application, including any intervening amendments made thereto, is incorporated herein by reference in its entirety.

### TECHNICAL FIELD

This application relates to geometric error measurement, and more particularly to a method and device for identifying a geometric error of a NC machine tool based on a modified 9-line method.

### BACKGROUND

The nine-line method is developed for indirect identification of geometric errors of NC machine tools, and has been extensively used in the related field due to the simple measurement process and intuitive and easily understandable identification model.

The nine-line method is generally performed as follows.

The positioning or straightness errors δ_{μv}ⁱ along the three trajectories shown in FIG. 1 are measured, and substituted into formula (1), and the corresponding coordinate values (xᵢ, yᵢ, z₁) are also substituted into the formula (1). The formula (1) is transformed into a matrix (2) to solve values of the six errors on the right side of the formula (2).

$$\{ \begin{matrix}{δ}_{xx}^{1} = {δ}_{xx} - {ε}_{zx} {y}_{1} + {ε}_{yx} {z}_{1} \\ {δ}_{yx}^{1} = {δ}_{yx} - {ε}_{zx} {z}_{1} + {ε}_{zx} {x}_{1} \\ {δ}_{xx}^{1} = {δ}_{zx} - {ε}_{yx} {x}_{1} + {ε}_{xx} {y}_{1} \\ {δ}_{xx}^{2} = {δ}_{xz} - {ε}_{zx} {y}_{2} + {ε}_{yx} {z}_{2} \\ {δ}_{yx}^{2} = {δ}_{yz} - {ε}_{xx} {z}_{2} + {ε}_{zx} {x}_{2} \\ {δ}_{xx}^{3} = {δ}_{xx} - {ε}_{zx} {y}_{3} + {ε}_{yx} {z}_{3}\end{matrix} \qquad ( 1 )$$

$$[ \begin{matrix}δ \text{?} \\ δ \text{?} \\ δ \text{?} \\ δ \text{?} \\ δ \text{?} \\ δ \text{?}\end{matrix} ] = [ \begin{matrix}1 & 0 & 0 & 0 & z \text{?} & - y \text{?} \\ 0 & 1 & 0 & - z \text{?} & 0 & x \text{?} \\ 0 & 0 & 1 & y \text{?} & - x \text{?} & 0 \\ 1 & 0 & 0 & 0 & {z}_{2} & - {y}_{2} \\ 0 & 1 & 0 & - z \text{?} & 0 & {x}_{2} \\ 1 & 0 & 0 & 0 & z \text{?} & - y \text{?}\end{matrix} ] [ \begin{matrix}δ \text{?} \\ δ \text{?} \\ δ \text{?} \\ δ \text{?} \\ δ \text{?} \\ δ \text{?}\end{matrix} ] \qquad ( 2 )$$

$$\text{?} \text{indicates text missing or illegible when filed}$$

However, the traditional nine line method has the following defects.

1. The nine-line method requires six measurements for the three trajectories in a single-axial direction as shown in FIG. 1. All errors for three axes necessitate “nine lines and eighteen measurements”. The measurement process involves repeated measurement of multiple errors along a single path, such that the measurement path is insufficient, resulting in limited error information and poor error generalization of various spatial points. Therefore, there is a need to increase the measurement paths without increasing the number of measurements.

2. Extensive measurement experiments conducted at different coordinate points have shown that the identification results are susceptible to the coordinates of the measurement points. Thus, the identification results will vary considerably among different measurement locations.

3. When the measurement coordinate system is substituted by the machine tool coordinate system, the error transmission between individual rigid bodies in the motion chain shown in FIG. 2 is ignored. According to the multibody system kinematics theory, the identification results of the nine-line method only reflect the error characteristics between the workpiece coordinate system and the tool coordinate system. In fact, the result is the cumulative effect of errors between multiple rigid bodies including the X, Y, and Z-axis worktables, spindle, machine bed, and other components between these two coordinate systems, and therefore cannot accurately describe the required error results.

### SUMMARY

In order to solve at least one of the technical problems existing in the prior art, the disclosure provides a method and device for identifying a geometric error of a numerical control (NC) machine tool based on a modified 9-line method.

In order to solve the technical problems, the disclosure adopts a method for identifying geometric errors of a NC machine tool based on a modified nine-line method, comprising:
(S110) based on multibody system kinematics theory and a topological structure of the NC machine tool, constructing a comprehensive error model by superimposing motion errors between a plurality of rigid bodies of the NC machine tool; and performing optimization based on the comprehensive error model and a preset fitness function to predict six optimal measurement positions;
(S120) establishing six linear measurement trajectories respectively at the six optimal measurement positions; wherein the six linear measurement trajectories are each parallel to one of an X-axis, a Y-axis, and a Z-axis; and measuring an error term for each of the six linear measurement trajectories to establish a first equation set having six first equations; and
(S130) performing geometric error simulation and identification for the NC machine tool based on the first equation set;
wherein the step (S120) comprises:
   densifying an original measurement trajectory, wherein each point in a measurement space is configured to correspond to an error vector represented by formula (3); a total of six second equation sets are obtained in a case that six points respectively on six parallel lines are taken, and the formula (3) is one of the six second equation sets corresponding to an i-th point, represented by:

$$\{ \begin{matrix}Δ {X}^{i} = {δ}_{xx}^{i} - {ε}_{zx}^{i} {y}_{i} + {ε}_{y x}^{i} {z}_{i} \\ Δ {Y}^{i} = {δ}_{y x}^{i} - {ε}_{xx}^{i} {z}_{i} + {ε}_{z κ}^{i} {x}_{i} \\ Δ {Z}^{i} = {δ}_{zx}^{i} - {ε}_{y x}^{i} {x}_{i} + {ε}_{xx}^{i} {y}_{i}\end{matrix} ; \qquad ( 3 )$$

wherein i=1, 2, . . . , 6; and
extracting one equation from each of the six second equation sets followed by combination to construct a third equation set; wherein a unique solution exists for the third equation set provided that the third equation set comprises six error terms corresponding to the six linear measurement trajectories, and a coordinate matrix of the formula (3) maintains full rank;
through MATLAB-assisted calculation, it is determined that the number of the third equation set satisfying requirements is 120;
selecting two from 120 third equation sets, respectively represented by formula (4) and formula (6):

$$\{ \begin{matrix}{δ}_{zx}^{1} = {δ}_{xx} - {ε}_{zx} {y}_{1} + {ε}_{yx} {z}_{1} \\ {δ}_{yz}^{2} = {δ}_{yz} - {ε}_{xx} {z}_{2} + {ε}_{zx} {x}_{2} \\ {δ}_{xx}^{3} = {δ}_{xx} - {ε}_{xx} {y}_{3} + {ε}_{yx} {z}_{3} \\ {δ}_{zx}^{4} = {δ}_{zx} - {ε}_{yx} {x}_{4} + {ε}_{xx} {y}_{4} \\ {δ}_{xx}^{5} = {δ}_{xx} - {ε}_{zx} {y}_{3} + {ε}_{yx} {z}_{5} \\ {δ}_{zx}^{6} = {δ}_{zx} - {ε}_{yx} {x}_{6} + {ε}_{zx} {y}_{6}\end{matrix} , \qquad ( 4 )$$

$$and$$

$$\{ \begin{matrix}{δ}_{xx}^{1} = {δ}_{xx} - {ε}_{zx} {y}_{1} + {ε}_{yx} {z}_{1} \\ {δ}_{yx}^{2} = {δ}_{yx} - {ε}_{xz} {z}_{2} + {ε}_{zx} {x}_{2} \\ {δ}_{zx}^{3} = {δ}_{zx} - {ε}_{yx} {x}_{3} + {ε}_{xz} {y}_{3} \\ {δ}_{xz}^{4} = {δ}_{xz} - {ε}_{zx} {y}_{4} + {ε}_{yz} {z}_{4} \\ {δ}_{yz}^{5} = {δ}_{yx} - {ε}_{xx} {z}_{5} + {ε}_{zx} {x}_{5} \\ {δ}_{zx}^{6} = {δ}_{zx} - {ε}_{zx} {y}_{6} + {ε}_{yz} {z}_{6}\end{matrix} ; \qquad ( 6 )$$

rewriting the formula (4) into formula (5) in a matrix form, represented by:

$$[ \begin{matrix}{δ}_{xz}^{1} \\ {δ}_{yz}^{2} \\ {δ}_{xz}^{3} \\ {δ}_{zx}^{4} \\ {δ}_{xz}^{5} \\ {δ}_{xz}^{6}\end{matrix} ] = [ \begin{matrix}1 & 0 & 0 & 0 & {z}_{1} & - {y}_{1} \\ 0 & 1 & 0 & - {z}_{2} & 0 & {x}_{2} \\ 1 & 0 & 0 & 0 & {z}_{3} & - {y}_{3} \\ 0 & 0 & 1 & {y}_{4} & - {x}_{4} & 0 \\ 1 & 0 & 0 & 0 & {z}_{3} & - {y}_{5} \\ 0 & 0 & 1 & {y}_{6} & - {x}_{6} & 0\end{matrix} ] [ \begin{matrix}{δ}_{xz} \\ {δ}_{yx} \\ {δ}_{zx} \\ {ε}_{xz} \\ {ε}_{yx} \\ {ε}_{zx}\end{matrix} ] ; \qquad ( 5 )$$

wherein the six linear measurement trajectories consist of a first trajectory, a second trajectory, a third trajectory, a fourth trajectory, a fifth trajectory, and a sixth trajectory; δₓₓ¹ indicates a positioning error along the X-axis on the first trajectory; δ_{yx}² indicates a straightness error of the X-axis in a direction of the Y-axis on the second trajectory; δₓₓ³ indicates a positioning error along the X-axis on the third trajectory; δ_{zx}⁴ indicates a straightness error of the X-axis in a direction of the Z-axis on the fourth trajectory; δₓₓ⁵ indicates a positioning error of the X-axis on the fifth trajectory; and δ_{zx}⁶ indicates a straightness error of the X-axis in the direction of the Z-axis on the sixth trajectory;
substituting measured values into a left side of the formula (5) and corresponding coordinate values into a right side of the formula (5) to solve the six error terms to be solved;
rewriting the formula (6) into formula (7) in a matrix form, expressed by:

$$[ \begin{matrix}δ \text{?} \\ δ \text{?} \\ δ \text{?} \\ δ \text{?} \\ δ \text{?} \\ δ \text{?}\end{matrix} ] = [ \begin{matrix}1 & 0 & 0 & 0 & {z}_{1} & - {y}_{1} \\ 0 & 1 & 0 & - {z}_{2} & 0 & x \text{?} \\ 0 & 0 & 1 & {y}_{1} & - x \text{?} & 0 \\ 1 & 0 & 0 & 0 & {z}_{4} & - {y}_{4} \\ 0 & 1 & 0 & - z \text{?} & 0 & x \text{?} \\ 1 & 0 & 0 & 0 & {z}_{6} & - {y}_{6}\end{matrix} ] [ \begin{matrix}{δ}_{xx} \\ {δ}_{yx} \\ {δ}_{zx} \\ {ε}_{xx} \\ {ε}_{yx} \\ {ε}_{zx}\end{matrix} ] ; \qquad ( 7 )$$

$$\text{?} \text{indicates text missing or illegible when filed}$$

and
δᵤᵥ represents a translation error of a v-axis in a direction of a u-axis, wherein the translation error comprises positioning error and straightness error; εᵤᵥ represents an angular error of the v-axis in the direction of the u-axis, wherein the u-axis is one of the X-axis, Y-axis, and Z-axis; and the v-axis is one of the X-axis, Y-axis, and Z-axis.

In an embodiment, the plurality of rigid bodies comprises an X-axis platform, a Y-axis platform, a Z-axis platform, a spindle, a tool, and a workpiece; and
the step of constructing the comprehensive error model by superimposing motion errors between the plurality of rigid bodies comprises:
   creating a reference coordinate system R on the NC machine tool in an initial state; creating a local coordinate system X on the X-axis platform; creating a local coordinate system Y on the Y-axis platform; creating a local coordinate system Z on the Z-axis platform; creating a local coordinate system S on the spindle; creating a local coordinate system T on the tool; creating a local coordinate system W on the workpiece;
   wherein X-axis, Y-axis and Z-axis directions of each of the local coordinate system X, the local coordinate system Y, the local coordinate system Z, the local coordinate system S, the local coordinate system T and the local coordinate system W are the same as X-axis, Y-axis and Z-axis directions of the reference coordinate system R, respectively; the Z-axis platform is directly connected to the spindle and the tool without relative motion, such that _{S}^{Z}T=I, wherein _{S}^{Z}T represents a homogeneous transformation matrix from the local coordinate system Z to the local coordinate system S, and I represents identity matrix; the spindle is directly connected to the tool, such that _{T}^{S}T=I, wherein _{T}^{S}T represents a homogeneous transformation matrix from the local coordinate system S to the local coordinate system T; and the workpiece is directly connected to the NC machine tool, such that _{R}^{W}T=I, wherein _{R}^{W}T represents a homogeneous transformation matrix from the local coordinate system W to the reference coordinate system R;
   in a case that the NC machine tool respectively moves x in the direction of the X-axis, y in the direction of the Y-axis and z in the direction of the Z-axis in an error-free state, a homogeneous transformation matrix from the local coordinate system W to the local coordinate system T is represented by:

$${}_{T}^{W} {T}^{i} = {}_{R}^{W} {T}^{i} \cdot {}_{T}^{R} {T}^{i} = {}_{R}^{W} {T}^{i} \cdot {}_{Y}^{R} {T}^{i} \cdot {}_{X}^{Y} {T}^{i} \cdot {}_{Z}^{X} {T}^{i} \cdot {}_{S}^{Z} {T}^{i} \cdot {}_{T}^{S} {T}^{i} = [ \begin{matrix}1 & 0 & 0 & x \\ 0 & 1 & 0 & y \\ 0 & 0 & 1 & z \\ 0 & 0 & 0 & 1\end{matrix} ] ; \qquad ( 8 )$$

wherein i represents a corresponding matrix in the error-free state; ₚ^{q}Tⁱ represents a homogeneous transformation matrix from coordinate system q to coordinate system p in the error-free state; and p and q each are one of the reference coordinate system R, the local coordinate system X, the local coordinate system Y, the local coordinate system Z, the local coordinate system S, the local coordinate system T and the local coordinate system W;
in a case that the NC machine tool respectively moves x in the direction of the X-axis, y in the direction of the Y-axis and z in the direction of the Z-axis in an error state, based on small-error hypothesis and homogeneous coordinate transformation, a homogeneous transformation matrix from the local coordinate system W to the local coordinate system T is represented by:

$${}_{T}^{W} {T}^{e} = {}_{R}^{W} {T}^{e} \cdot {}_{T}^{R} {T}^{e} = {}_{R}^{W} {T}^{e} \cdot {}_{Y}^{R} {T}^{e} \cdot {}_{X}^{Y} {T}^{e} \cdot {}_{Z}^{X} {T}^{e} \cdot {}_{S}^{Z} {T}^{e} \cdot {}_{T}^{S} {T}^{e} ; \qquad ( 12 )$$

wherein e represents a corresponding matrix in the error state; ₚ^{q}T^{e} represents a homogeneous transformation matrix from coordinate system q to coordinate system p in the error state; each of p and q is one of the reference coordinate system R, the local coordinate system X, the local coordinate system Y, the local coordinate system Z, the local coordinate system S, the local coordinate system T and the local coordinate system W; and the homogeneous transformation matrix _{T}^{W}T^{e} is configured to be derived from multiplication of the homogeneous transformation matrix _{T}^{W}Tⁱ by a transformation matrix _{T}^{W}E from the local coordinate system W to the local coordinate system T in the error state, expressed as:

$${}_{T}^{W} {T}^{e} = {}_{T}^{W} {{T}^{i}}_{T}^{W} E ; \qquad ( 13 )$$

based on the small-error hypothesis, the transformation matrix from the local coordinate system W to the local coordinate system T is represented by:

$${}_{T}^{W} E = [ \begin{matrix}1 & - {Δε}_{x} & {Δε}_{y} & {Δ}_{x} \\ {Δε}_{z} & 1 & - {Δε}_{x} & {Δ}_{y} \\ - {Δε}_{y} & {Δε}_{x} & 1 & {Δ}_{z} \\ 0 & 0 & 0 & 1\end{matrix} ] ; \qquad ( 14 )$$

wherein Δₓ represents a positional error deviation of an actual cutting point of the tool relative to an ideal cutting point in the direction of the X-axis, Δ_{y} represents a positional error deviation of the actual cutting point of the tool relative to the ideal cutting point in the direction of the Y-axis, and Δ_{z} represents a positional error deviation of the actual cutting point of the tool relative to the ideal cutting point in the direction of the Z-axis; Δεₓ represents an orientation error deviation of the actual cutting point of the tool relative to the ideal cutting point in the direction of the X-axis, Δε_{y} represents an orientation error deviation of the actual cutting point of the tool relative to the ideal cutting point in the direction of the Y-axis, and Δε_{z} represents an orientation error deviation of the actual cutting point of the tool relative to the ideal cutting point in the direction of the Z-axis;
substituting formulas (8), (12), and (14) into formula (13) based on the small-error hypothesis while simultaneously neglecting second-order and higher-order small quantities and eliminating distances brought by three-directional translations, such that the transformation matrix _{T}^{W}E is expressed as:

$$( 15 )$$

$${}_{T}^{W} E = [ \begin{matrix}1 & - ε \text{?} - ε \text{?} - ε \text{?} & ε \text{?} + ε \text{?} + ε \text{?} \\ {ε}_{x x} + ε \text{?} + ε \text{?} & 1 & - ε \text{?} - ε \text{?} - ε \text{?} \\ - {ε}_{y x} - ε \text{?} - {ε}_{y x} & ε \text{?} + {ε}_{x y} + ε \text{?} & 1 \\ 0 & 0 & 0\end{matrix} \begin{matrix}\begin{matrix}{δ}_{x x} + δ \text{?} + δ \text{?} + \\ z ε \text{?} + z ε \text{?} - zS \text{?}\end{matrix} \\ \begin{matrix}δ \text{?} + δ \text{?} + δ \text{?} - z ε \text{?} - \\ z ε \text{?} + x ε \text{?} - zS \text{?} - xS \text{?}\end{matrix} \\ δ \text{?} + δ \text{?} + δ \text{?} - x ε \text{?} \\ 1\end{matrix} ] ;$$

$$\text{?} \text{indicates text missing or illegible when filed}$$

extracting terms corresponding to Δₓ, Δ_{y} and Δ_{z} from a matrix of formula (15) to obtain the comprehensive error model, expressed as:

$$\{ \begin{matrix}{Δ}_{x} = {δ}_{xx} + {δ}_{xy} + δ \text{?} + z {ε}_{yx} + z ε \text{?} - zS \text{?} \\ {Δ}_{y} = δ \text{?} + δ \text{?} + {δ}_{yz} - z {ε}_{xy} + x ε \text{?} - zS \text{?} \\ {Δ}_{z} = δ \text{?} + δ \text{?} + δ \text{?} - x ε \text{?}\end{matrix} - {xS}_{xy} ; \qquad ( 16 )$$

$$\text{?} \text{indicates text missing or illegible when filed}$$

wherein Sᵤᵥ represents a perpendicularity error of the v-axis in the direction of the u-axis; the u-axis is one of the X-axis, Y-axis, and Z-axis; and the v-axis is one of the X-axis, Y-axis, and Z-axis.

In an embodiment, the step of performing optimization based on the comprehensive error model and the preset fitness function to predict the six optimal measurement positions comprises:
combining coordinate values of any six measurement points from a plurality of measurement points as an individual to obtain a plurality of individuals; and
introducing the preset fitness function to evaluate each of the plurality of individuals; and selecting an individual with a smallest fitness among the plurality of individuals as an optimal individual; wherein six measurement points corresponding to the optimal individual are selected as the six optimal measurement positions.

In an embodiment, the optimal individual is determined through steps of:
(S210) encoding a plurality of individuals, and initializing a population formed by the plurality of individuals;
(S220) evaluating a fitness of each of the plurality of individuals in the population using the preset fitness function;
(S230) determining whether a current individual among the plurality of individuals has a rank of 6; if not, randomly assigning a preset large fitness value to the current individual to mark the current individual as unqualified, and returning the current individual to the population; otherwise, proceeding to step (S240);
(S240) determining whether the number of iterations reaches a preset number of iterations; if yes, proceeding to step (S250); and if not, performing selection, crossover, and mutation operations to generate a new population and returning to step (S220); and
(S250) determining the current individual as the optimal individual.

In an embodiment, the preset fitness function is established through steps of:
respectively expanding a plurality of variables in the measurement space through a multi-dimensional grid interpolation operation to obtain a plurality of matrices of the same dimension;
calculating the plurality of matrices based on the comprehensive error model to obtain a plurality of comprehensive error matrices of the same dimension, and constructing a mathematical model based on the plurality of comprehensive error matrices to describe an error distribution throughout the measurement space; wherein the plurality of comprehensive error matrices are respectively corresponding to the plurality of variables; and
calculating standard deviations of mean error differences for the plurality of individuals and determining a coefficient of variation using the mathematical model as identification results.

The present disclosure further provides a device for identifying geometric errors of a NC machine tool based on a modified nine-line method, comprising:
a first construction module;
a second construction module;
a simulation and identification module;
wherein the first construction module is configured for constructing a comprehensive error model by superimposing motion errors between a plurality of rigid bodies of the NC machine tool based on multibody system kinematics theory and a topological structure of the NC machine tool; and performing optimization based on the comprehensive error model and a preset fitness function to predict six optimal measurement positions;
the second construction module is configured for establishing six linear measurement trajectories respectively at the six optimal measurement positions; wherein the six linear measurement trajectories are each parallel to one of an X-axis, a Y-axis, and a Z-axis; and measuring an error term for each of the six linear measurement trajectories to establish a first equation set having six first equations; and;
the simulation and identification module is configured for a step of:
performing geometric error simulation and identification for the NC machine tool based on the first equation set through steps of:
   densifying an original measurement trajectory, wherein each point in a measurement space is configured to correspond to an error vector represented by formula (3); a total of six second equation sets are obtained in a case that six points respectively on six parallel lines are taken, and the formula (3) is one of the six second equation sets corresponding to an i-th point, represented by:

$$\{ \begin{matrix}Δ {X}^{i} = {δ}_{x x}^{i} − {ε}_{𝓏 x}^{i} {y}_{i} + {ε}_{y x}^{i} {z}_{i} \\ Δ {Y}^{i} = {δ}_{y x}^{i} − {ε}_{x x}^{i} {z}_{i} + {ε}_{𝓏 x}^{i} {x}_{i} \\ Δ {Z}^{i} = {δ}_{𝓏 x}^{i} − {ε}_{y x}^{i} {x}_{i} + {ε}_{x x}^{i} {y}_{i}\end{matrix} ; \qquad ( 3 )$$

wherein i=1, 2, . . . , 6; and
extracting one equation from each of the six second equation sets followed by combination to construct a third equation set; wherein a unique solution exists for the third equation set provided that the third equation set comprises six error terms corresponding to the six linear measurement trajectories, and a coordinate matrix of the formula (3) maintains full rank;
through MATLAB-assisted calculation, it is determined that the number of the third equation set satisfying requirements is 120;
selecting two from 120 third equation sets, respectively represented by formula (4) and formula (6):

$$\{ \begin{matrix}{δ}^{1} \text{?} = δ \text{?} - ε \text{?} {y}_{1} + ε \text{?} {z}_{1} \\ {δ}_{yz}^{2} = δ \text{?} - ε \text{?} {z}_{2} + ε \text{?} {x}_{2} \\ {δ}^{3} \text{?} = δ \text{?} - ε \text{?} {y}_{3} + ε \text{?} {z}_{3} \\ {δ}_{zx}^{4} = δ \text{?} - ε \text{?} {x}_{4} + {ε}_{xx} {y}_{4} \\ {δ}^{5} \text{?} = δ \text{?} - ε \text{?} {y}_{5} + ε \text{?} {z}_{5} \\ {δ}^{6} \text{?} = δ \text{?} - ε \text{?} {x}_{6} + ε \text{?} {y}_{6}\end{matrix} , \qquad ( 4 )$$

$$and$$

$$\{ \begin{matrix}{δ}^{1} \text{?} = δ \text{?} - ε \text{?} {y}_{1} + ε \text{?} {z}_{1} \\ {δ}_{yz}^{2} = δ \text{?} - ε \text{?} {z}_{2} + ε \text{?} {x}_{2} \\ {δ}^{3} \text{?} = δ \text{?} - ε \text{?} {y}_{3} + ε \text{?} {z}_{3} \\ {δ}^{4} \text{?} = δ \text{?} - ε \text{?} {x}_{4} + ε \text{?} {y}_{4} \\ {δ}^{5} \text{?} = δ \text{?} - ε \text{?} {y}_{5} + ε \text{?} {z}_{5} \\ {δ}^{6} \text{?} = δ \text{?} - ε \text{?} {x}_{6} + ε \text{?} {y}_{6}\end{matrix} ; \qquad ( 6 )$$

$$\text{?} \text{indicates text missing or illegible when filed}$$

rewriting the formula (4) into formula (5) in a matrix form, represented by:

$$[ \begin{matrix}{δ}_{xx}^{1} \\ {δ}_{yx}^{2} \\ {δ}_{xx}^{3} \\ {δ}_{zx}^{4} \\ {δ}^{5} \text{?} \\ {δ}_{zx}^{6}\end{matrix} ] = [ \begin{matrix}1 & 0 & 0 & 0 & {z}_{1} & − {y}_{1} \\ 0 & 1 & 0 & − {z}_{2} & 0 & {x}_{2} \\ 1 & 0 & 0 & 0 & {z}_{3} & − {y}_{3} \\ 0 & 0 & 1 & {y}_{4} & − {x}_{4} & 0 \\ 1 & 0 & 0 & 0 & {z}_{3} & − {y}_{5} \\ 0 & 0 & 1 & {y}_{6} & − {x}_{6} & 0\end{matrix} ] [ \begin{matrix}{δ}_{xx} \\ {δ}_{yx} \\ ε \text{?} \\ ε \text{?} \\ {ε}_{yx} \\ {ε}_{zx}\end{matrix} ] ; \qquad ( 5 )$$

$$\text{?} \text{indicates text missing or illegible when filed}$$

wherein the six linear measurement trajectories consist of a first trajectory, a second trajectory, a third trajectory, a fourth trajectory, a fifth trajectory, and a sixth trajectory; δₓₓ¹ indicates a positioning error along the X-axis on the first trajectory; δ_{yx}² indicates a straightness error ofthe X-axis in a direction ofthe Y-axis on the second trajectory; δₓₓ³ indicates a positioning error along the X-axis on the third trajectory; δ_{zx}⁴ indicates a straightness error of the X-axis in a direction of the Z-axis on the fourth trajectory; δₓₓ⁵ indicates a positioning error of the X-axis on the fifth trajectory; and δ_{zx}⁶ indicates a straightness error of the X-axis in the direction of the Z-axis on the sixth trajectory;
substituting measured values into a left side of the formula (5) and corresponding coordinate values into a right side of the formula (5) to solve the six error terms to be solved;
rewriting the formula (6) into formula (7) in a matrix form, expressed by:

$$[ \begin{matrix}{δ}_{xx}^{1} \\ {δ}_{yx}^{2} \\ {δ}_{xx}^{3} \\ {δ}_{zx}^{4} \\ {δ}^{5} \text{?} \\ {δ}_{zx}^{6}\end{matrix} ] = [ \begin{matrix}1 & 0 & 0 & 0 & {z}_{1} & − {y}_{1} \\ 0 & 1 & 0 & − {z}_{2} & 0 & {x}_{2} \\ 0 & 0 & 1 & y \text{?} & − x \text{?} & 0 \\ 1 & 0 & 0 & 0 & {z}_{4} & - {y}_{4} \\ 0 & 1 & 0 & − z \text{?} & 0 & x \text{?} \\ 1 & 0 & 0 & 0 & {z}_{6} & - {y}_{6}\end{matrix} ] [ \begin{matrix}{δ}_{xx} \\ {δ}_{yx} \\ ε \text{?} \\ ε \text{?} \\ {ε}_{yx} \\ {ε}_{zx}\end{matrix} ] ; \qquad ( 7 )$$

$$\text{?} \text{indicates text missing or illegible when filed}$$

and
δᵤᵥ represents a translation error of a v-axis in a direction of a u-axis, wherein the translation error comprises positioning error and straightness error; εᵤᵥ represents an angular error of the v-axis in the direction of the u-axis, wherein the u-axis is one of the X-axis, Y-axis, and Z-axis; and the v-axis is one of the X-axis, Y-axis, and Z-axis.

The present disclosure has benefits as follows.

On one hand, the identification process of the nine-line method shows that the identification equations set determines the measurement strategy during the actual operation. This present application optimizes the measurement strategy by changing the combinations of the identification equations, achieving denser processing of measurement trajectories without increasing the number of measurements, thereby collecting more error information from the spatial domain.

On the other hand, this present application simulates a comprehensive error field established based on the topological structure of the target machine tool. Using an adaptive genetic algorithm, it traverses and searches within this comprehensive error field to predict the identification results at various points, ultimately obtaining the measurement positions that have the least impact on the identification results.

### BRIEF DESCRIPTION OF THE DRAWINGS

The present disclosure will be described in further detail below with reference to the accompanying drawings and embodiments. The above and other features of this disclosure will become more apparent, and the same reference numbers in the accompanying drawings indicate the same or similar output voltages. Obviously, presented in the accompanying drawings are only some embodiments of the present disclosure. Other embodiments may also be obtained by those skilled in the art according to these accompanying drawings without making creative effort.

FIG. 1 is a schematic diagram of the measurement trajectory of the traditional nine-line method;

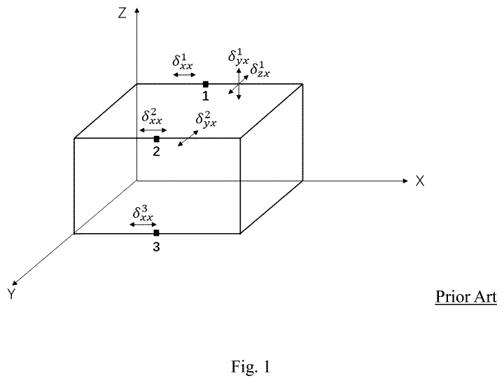

FIG. 2 is a schematic diagram of a motion chain of the machine tool involved in the prior art;

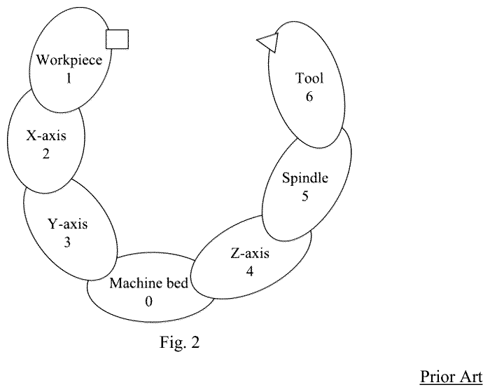

FIG. 3 schematically illustrates measurement trajectory of a method for identifying geometric errors of the NC machine tool according to an embodiment of the present disclosure;

FIG. 4 is a flowchart of the method according to an embodiment of the present disclosure;

FIG. 5 schematically shows a simplified motion chain of the method according to an embodiment of the present disclosure;

FIG. 6 schematically depicts application of the method according to an embodiment of the present disclosure in the movement structure of the translational axis of an RRTTT-type (R: rotational axis; and T: translational axis) five-axis NC machine tool;

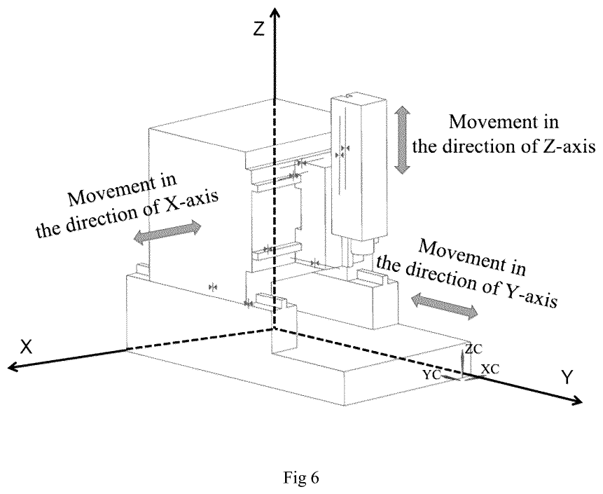

FIG. 7 is a schematic diagram of the process from the identification to compensation in the traditional nine-line method;

FIG. 8 is a schematic diagram of the distribution of measurement points within the error field established by the method according to an embodiment of the present disclosure;

FIG. 9 is a principle diagram of the algorithm optimization in the method according to an embodiment of the present disclosure;

FIG. 10 schematically shows the measurement of straightness error in the X-axis direction when applying the method according to an embodiment of the present disclosure;

FIG. 11A is a schematic diagram of the positioning error values when applying the method according to an embodiment of the present disclosure;

FIG. 11B is a schematic diagram of the straightness error values when applying the method according to an embodiment of the present disclosure;

FIG. 11C is another schematic diagram of the straightness error values when applying according to an embodiment of the present disclosure;

FIG. 11D is a first schematic diagram of the angular error values when applying the method according to an embodiment of the present disclosure;

FIG. 11E is a second schematic diagram of the angular error values when applying the method according to an embodiment of the present disclosure;

FIG. 11F is a third schematic diagram of the angular error values when applying the method according to an embodiment of the present disclosure;

FIG. 12A is a schematic diagram of the positioning error values when applying the traditional nine-line method;

FIG. 12B is a first schematic diagram of the straightness error values when applying the traditional nine-line method;

FIG. 12C is a second schematic diagram of the straightness error values when applying the traditional nine-line method;

FIG. 12D is a first schematic diagram of the angular error values when applying the traditional nine-line method;

FIG. 12E is a second schematic diagram of the angular error values when applying the traditional nine-line method;

FIG. 12F is a third schematic diagram of the angular error values when applying the traditional nine-line method;

FIG. 13A shows comparison among the method according to an embodiment of the present disclosure, the traditional nine-line method and the actual measurement in terms of the positioning error values;

FIG. 13B shows comparison among the method according to an embodiment of the present disclosure, the traditional nine-line method and the actual measurement in terms of the straightness error values; and

FIG. 13C shows comparison among the method according to an embodiment of the present disclosure, the traditional nine-line method and the actual measurement in terms of the straightness error values.

### DETAILED DESCRIPTION OF EMBODIMENTS

A clear and comprehensive description of the inventive concepts, specific solution, and technical effects of the present disclosure is provided below with reference to the embodiments and accompanying figures, to facilitate understanding the objectives, approach, and effects of the present disclosure. It should be noted that, where there is no conflict, the embodiments and features described in this present disclosure can be combined with one another. Identical reference numerals used throughout the figures indicate the same or similar parts. The technical solutions in individual embodiments can also be appropriately combined to form other embodiments understood by those skilled in the art.

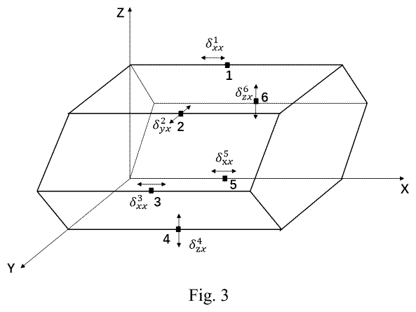

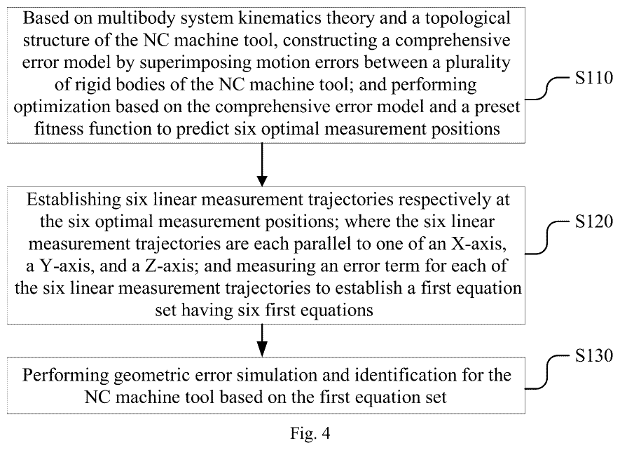

As shown in FIGS. 3-4, Embodiment 1 of the present disclosure provides a method for identifying geometric errors of a NC machine tool based on a modified nine-line method, which is performed as follows.

(S110) Based on multibody system kinematics theory and a topological structure of the NC machine tool, a comprehensive error model is constructed by superimposing motion errors between a plurality of rigid bodies of the NC machine tool; and optimization is performed based on the comprehensive error model and a preset fitness function to predict six optimal measurement positions.

(S120) Six linear measurement trajectories respectively at the six optimal measurement positions are established. Where the six linear measurement trajectories are each parallel to one of an X-axis, a Y-axis, and a Z-axis; and measuring an error term for each of the six linear measurement trajectories to establish a first equation set having six first equations.

(S130) Geometric error simulation and identification for the NC machine tool are performed based on the first equation set.

In step (S120), the identification equation set is modified by densifying the original measurement trajectory. Taking the X-axis direction as an example, when the six geometric errors are the variables to be solved, an equation set with six equations needs to be established. As can be seen from formula (2), a unique solution of the equation set exists as long as a coordinate matrix of the equation set with six equations maintains a full-rank matrix.

Each point in a measurement space is configured to correspond to an error vector represented by formula (3). A total of six second equation sets are obtained in a case that six points respectively on the six parallel lines are taken, and the formula (3) is one of the six second equation sets corresponding to an i-th point, represented by:

$$\{ \begin{matrix}Δ {X}^{i} = {δ}_{x x}^{i} − {ε}_{𝓏 x}^{i} {y}_{i} + {ε}_{y x}^{i} {z}_{i} \\ Δ {Y}^{i} = {δ}_{y x}^{i} − {ε}_{x x}^{i} {z}_{i} + {ε}_{𝓏 x}^{i} {x}_{i} \\ Δ {Z}^{i} = {δ}_{𝓏 x}^{i} − {ε}_{y x}^{i} {x}_{i} + {ε}_{x x}^{i} {y}_{i}\end{matrix} ; \qquad ( 3 )$$

In the above formula, i=1, 2, . . . 6. One equation is extracted from each of the six second equation sets to construct a third equation set; where a unique solution exists for the third equation set provided that the third equation set includes six error terms corresponding to the six linear measurement trajectories, and a coordinate matrix of the formula (3) maintains full rank.

The number of the third equation set satisfying requirements is determined to be 120 through MATLAB-assisted calculation. Due to the direct impact of the coefficient matrix on the analytical results, two sets were selected to enrich the optimization results of subsequent algorithms.

The first set of the 120 third equation sets shown as FIG. 3. The six linear measurement trajectories consist of a first trajectory, a second trajectory, a third trajectory, a fourth trajectory, a fifth trajectory, and a sixth trajectory. Take the measurement of X-axis as example, a positioning error along the X-axis on the first trajectory (δₓₓ¹); a straightness error of the X-axis in a direction of the Y-axis on the second trajectory (δ_{yx}²); a positioning error along the X-axis on the third trajectory (δₓₓ³); a straightness error of the X-axis in a direction of the Z-axis on the fourth trajectory (δ_{zx}⁴); a positioning error of the X-axis on the fifth trajectory (δₓₓ⁵); and a straightness error of the X-axis in the direction of the Z-axis on the sixth trajectory (δ_{zx}⁶) are measured respectively to obtain the equation set having 6 equations as formula (4).

$$\{ \begin{matrix}{δ}^{1} \text{?} = δ \text{?} - ε \text{?} {y}_{1} + ε \text{?} {z}_{1} \\ {δ}^{2} \text{?} = δ \text{?} - ε \text{?} {z}_{2} + ε \text{?} {x}_{2} \\ {δ}^{3} \text{?} = δ \text{?} - ε \text{?} {y}_{3} + ε \text{?} {z}_{3} \\ {δ}_{zx}^{4} = δ \text{?} - ε \text{?} {x}_{4} + {ε}_{xx} {y}_{4} \\ {δ}^{5} \text{?} = δ \text{?} - ε \text{?} {y}_{5} + ε \text{?} {z}_{5} \\ {δ}^{6} \text{?} = δ \text{?} - ε \text{?} {x}_{6} + ε \text{?} {y}_{6}\end{matrix} , \qquad ( 4 )$$

$$\text{?} \text{indicates text missing or illegible when filed}$$

The formula (4) is rewritten into formula (5) in a matrix form. Six measured values are substituted into a left side of the formula (5) and corresponding coordinate values are substituted into a right side of the formula (5) to solve the six error terms to be solved.

The formula (5) is represented by:

$$[ \begin{matrix}{δ}_{xx}^{1} \\ {δ}_{yx}^{2} \\ {δ}_{xx}^{3} \\ {δ}_{zx}^{4} \\ {δ}^{5} \text{?} \\ {δ}_{zx}^{6}\end{matrix} ] = [ \begin{matrix}1 & 0 & 0 & 0 & {z}_{1} & − {y}_{1} \\ 0 & 1 & 0 & − {z}_{2} & 0 & {x}_{2} \\ 1 & 0 & 0 & 0 & {z}_{3} & − {y}_{3} \\ 0 & 0 & 1 & {y}_{4} & − {x}_{4} & 0 \\ 1 & 0 & 0 & 0 & {z}_{5} & − {y}_{5} \\ 0 & 0 & 1 & {y}_{6} & − {x}_{6} & 0\end{matrix} ] [ \begin{matrix}{δ}_{xx} \\ {δ}_{yx} \\ ε \text{?} \\ {ε}_{xx} \\ {ε}_{yx} \\ {ε}_{zx}\end{matrix} ] ; \qquad ( 5 )$$

$$\text{?} \text{indicates text missing or illegible when filed}$$

The second set among the 120 third equation sets is shown in formula (6) for cross search. The measurement process is the same as the above method, which will not be repeated. The formula (6) is represented by:

$$\{ \begin{matrix}{δ}^{1} \text{?} = δ \text{?} - ε \text{?} {y}_{1} + ε \text{?} {z}_{1} \\ {δ}^{2} \text{?} = δ \text{?} - ε \text{?} {z}_{2} + ε \text{?} {x}_{2} \\ {δ}^{3} \text{?} = δ \text{?} - ε \text{?} {y}_{3} + ε \text{?} {z}_{3} \\ {δ}^{4} \text{?} = δ \text{?} - ε \text{?} {x}_{4} + ε \text{?} {y}_{4} \\ {δ}^{5} \text{?} = δ \text{?} - ε \text{?} {y}_{5} + ε \text{?} {z}_{5} \\ {δ}^{6} \text{?} = δ \text{?} - ε \text{?} {x}_{6} + ε \text{?} {y}_{6}\end{matrix} ; \qquad ( 6 )$$

$$\text{?} \text{indicates text missing or illegible when filed}$$

The formula (6) is rewritten into formula (7) in a matrix form, expressed by:

$$[ \begin{matrix}{δ}_{xx}^{1} \\ {δ}_{yx}^{2} \\ {δ}_{xx}^{3} \\ {δ}_{zx}^{4} \\ {δ}^{5} \text{?} \\ {δ}_{zx}^{6}\end{matrix} ] = [ \begin{matrix}1 & 0 & 0 & 0 & {z}_{1} & − {y}_{1} \\ 0 & 1 & 0 & − {z}_{2} & 0 & {x}_{2} \\ 0 & 0 & 1 & y \text{?} & − x \text{?} & 0 \\ 1 & 0 & 0 & 0 & {z}_{4} & - {y}_{4} \\ 0 & 1 & 0 & − z \text{?} & 0 & {x}_{5} \\ 1 & 0 & 0 & 0 & {z}_{6} & - {y}_{6}\end{matrix} ] [ \begin{matrix}{δ}_{xx} \\ {δ}_{yx} \\ ε \text{?} \\ ε \text{?} \\ {ε}_{yx} \\ {ε}_{zx}\end{matrix} ] ; \qquad ( 7 )$$

$$\text{?} \text{indicates text missing or illegible when filed}$$

In the above formula, δᵤᵥ represents a translation error of a v-axis in a direction of a u-axis, where the translation error includes positioning error and straightness error; εᵤᵥ represents an angular error of the v-axis in the direction of the u-axis, where the u-axis is one of the X-axis, Y-axis, and Z-axis; and the v-axis is one of the X-axis, Y-axis, and Z-axis.

This method involves obtaining six linear measurement trajectories that are each parallel to a single motion axis direction (X-axis, Y-axis and Z-axis), with each trajectory measuring a specific type of error. A total of six measurements are taken. If measurements are to be conducted in all three directions, eighteen measurement trajectories would require a total of eighteen measurements. The traditional nine-line method also requires nine trajectories for a total of eighteen measurements, while the new measurement method provided herein densifies the measurement trajectories without increasing the total number of measurements.

A preferred embodiment of the present disclosure is described as follows. The step of constructing the comprehensive error model by superimposing motion errors between the plurality of rigid bodies to construct the comprehensive error model based on multibody system kinematics theory and the topological structure of the NC machine tool includes the following steps.

Accurately predicting the optimal measurement positions requires computer simulation of an error field that corresponds to the NC machine tool's processing space. The comprehensive error model is derived from multibody system kinematics theory and the topological structure of the NC machine tool. Thus, a comprehensive error mathematical model is used to establish the error field.

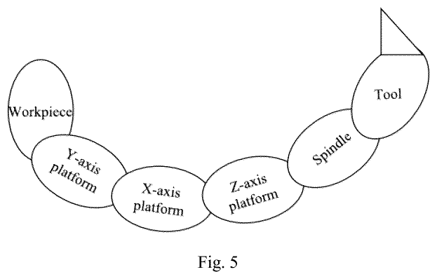

As shown in FIG. 5, according to the simplified motion chain based on research, a reference coordinate system R on the NC machine tool in an initial state is created. A local coordinate system X on the X-axis platform, a local coordinate system Y on the Y-axis platform, a local coordinate system Z on the Z-axis platform, a local coordinate system S on the spindle, a local coordinate system T on the tool and a local coordinate system W on the workpiece are created. X-axis, Y-axis and Z-axis directions of each of the local coordinate system X, the local coordinate system Y, the local coordinate system Z, the local coordinate system S, the local coordinate system T and the local coordinate system W are the same as X-axis, Y-axis and Z-axis directions of the reference coordinate system R, respectively.

The Z-axis platform is directly connected to the spindle and the tool without relative motion, such that _{S}^{Z}T=I, where _{S}^{Z}T represents a homogeneous transformation matrix from the local coordinate system Z to the local coordinate system S; and I represents identity matrix; the spindle is directly connected to the tool, such that _{T}^{S}T=I, where _{T}^{S}T represents a homogeneous transformation matrix from the local coordinate system S to the local coordinate system T; and the workpiece is directly connected to the NC machine tool, such that _{R}^{W}T=I, where _{R}^{W}T represents a homogeneous transformation matrix from the local coordinate system W to the reference coordinate system R.

In a case that the NC machine tool respectively moves x in the direction of the X-axis, y in the direction of the Y-axis and z in the direction of the Z-axis in an error-free state, a homogeneous transformation matrix from the local coordinate system W to the local coordinate system T is represented by:

$${}_{T}^{W} {T}^{i} = {}_{R}^{W} {T}^{i} \cdot {}_{T}^{R} {T}^{i} = {}_{R}^{W} {T}^{i} \cdot {}_{Y}^{R} {T}^{i} \cdot {}_{X}^{Y} {T}^{i} \cdot {}_{Z}^{X} {T}^{i} \cdot {}_{S}^{Z} {T}^{i} \cdot {}_{T}^{S} {T}^{i} = [ \begin{matrix}1 & 0 & 0 & x \\ 0 & 1 & 0 & y \\ 0 & 0 & 1 & z \\ 0 & 0 & 0 & 1\end{matrix} ] . \qquad ( 8 )$$

In the above formula (8), i represents a corresponding matrix in the error-free state; ₚ^{q}Tⁱ represents a homogeneous transformation matrix from coordinate system q to coordinate system p in the error-free state; and p and q each are one of the reference coordinate system R, the local coordinate system X, the local coordinate system Y, the local coordinate system Z, the local coordinate system S, the local coordinate system T and the local coordinate system W.

In the actual state (error state), the transformation matrices of each motion axis exhibit slight movements in all directions. For example, the Y-axis platform has three translation errors (δ_{yy}, δ_{xy} and δ_{zy}) and three angular errors (ε_{yy}, ε_{xy} and ε_{zy}). When the Y-axis platform moves y, based on the small-error hypothesis and homogeneous coordinate transformation, the homogeneous transformation matrix from the reference coordinate system R to the Y-axis platform is represented as _{Y}^{R}T^{e}, expressed as formula (9). ₚ^{q}T^{e} represents a homogeneous transformation matrix from coordinate system q to coordinate system p in the error state; p and q each are one of the reference coordinate system R, the local coordinate system X, the local coordinate system Y, the local coordinate system Z, the local coordinate system S, the local coordinate system T and the local coordinate system W.

$${}_{Y}^{R} {T}^{e} = [ \begin{matrix}1 & − {ε}_{zy} & {ε}_{yy} & {δ}_{xy} \\ {ε}_{xy} & 1 & − {ε}_{xy} & {δ}_{yy} + y \\ − {ε}_{yy} & {ε}_{xy} & 1 & {δ}_{zy} \\ 0 & 0 & 0 & 1\end{matrix} ] . \qquad ( 9 )$$

When the X-platform moves x, there are three translation errors (δₓₓ, δ_{yx}, δ_{zx}), three angular errors (εₓₓ, ε_{yx}, ε_{zx}) and a vertical error (S_{xy}). Based on the small-error hypothesis and homogeneous coordinate transformation, the homogeneous transformation matrix from the Y-axis platform Y to the X-axis platform X is represented as _{X}^{Y}T^{e}, expressed as formula (10). ₚ^{q}T^{e} represents a homogeneous transformation matrix from coordinate system q to coordinate system p in the error state; p and q each are one of the reference coordinate system R, the local coordinate system X, the local coordinate system Y, the local coordinate system Z, the local coordinate system S, the local coordinate system T and the local coordinate system W. Suv represents a perpendicularity error of the v-axis in the direction of the u-axis.

$${}_{X}^{Y} {T}^{e} = [ \begin{matrix}1 & − {ε}_{zx} & {ε}_{yx} & {δ}_{xx} + x \\ {ε}_{zx} & 1 & − {ε}_{xx} & {δ}_{yx} + {xS}_{xy} \\ − {ε}_{yx} & {ε}_{xx} & 1 & {δ}_{zx} \\ 0 & 0 & 0 & 1\end{matrix} ] . \qquad ( 10 )$$

When the Z-platform moves z, there are three translation errors (δ_{xz}, δ_{yz} and δ_{zz}), three angular errors (εₓₓ, ε_{yz} and ε_{zz}) and two vertical errors (S_{xz} and S_{yz}). Based on the small-error hypothesis and homogeneous coordinate transformation, the homogeneous transformation matrix from the X-axis platform to the Z-axis platform is represented as _{Z}^{X}T^{e}, expressed as formula (11). ₚ^{q}T^{e} represents a homogeneous transformation matrix from coordinate system q to coordinate system p in the error state; p and q each are one of the reference coordinate system R, the local coordinate system X, the local coordinate system Y, the local coordinate system Z, the local coordinate system S, the local coordinate system T and the local coordinate system W.

$${}_{Z}^{Y} {T}^{e} = [ \begin{matrix}1 & − {ε}_{zz} & {ε}_{yz} & {δ}_{xz} - {zS}_{xz} \\ {ε}_{zz} & 1 & − {ε}_{xz} & {δ}_{yz} - {zS}_{yz} \\ − {ε}_{yz} & {ε}_{xz} & 1 & {δ}_{zz} + z \\ 0 & 0 & 0 & 1\end{matrix} ] . \qquad ( 11 )$$

In a case that the NC machine tool respectively moves x in the direction of the X-axis, y in the direction of the Y-axis and z in the direction of the Z-axis in an error state, based on small-error hypothesis and homogeneous coordinate transformation, a homogeneous transformation matrix from the local coordinate system W to the local coordinate system T is represented by:

$${}_{T}^{W} {T}^{e} = {}_{R}^{W} {T}^{e} \cdot {}_{T}^{R} {T}^{e} = {}_{R}^{W} {T}^{e} \cdot {}_{Y}^{R} {T}^{e} \cdot {}_{X}^{Y} {T}^{e} \cdot {}_{Z}^{X} {T}^{e} \cdot {}_{S}^{Z} {T}^{e} \cdot {}_{T}^{S} {T}^{e} . \qquad ( 12 )$$

In the formula (12), e represents a corresponding matrix in the error state; ₚ^{q}T^{e} represents a homogeneous transformation matrix from coordinate system q to coordinate system p in the error state; p and q each are one of the reference coordinate system R, the local coordinate system X, the local coordinate system Y, the local coordinate system Z, the local coordinate system S, the local coordinate system T and the local coordinate system W; and the homogeneous transformation matrix _{T}^{W}T^{e} is configured to be derived from multiplication of the homogeneous transformation matrix _{T}^{W}Tⁱ by a transformation matrix _{T}^{W}E from the local coordinate system W to the local coordinate system T in the error state, expressed as:

$${}_{T}^{W} {T}^{e} = {}_{T}^{W} {T}^{i} \cdot {}_{T}^{W} E . \qquad ( 13 )$$

Based on the small-error hypothesis, the transformation matrix from the local coordinate system W to the local coordinate system T is represented by:

$${}_{T}^{W} {E}^{} = [ \begin{matrix}1 & − Δ {ε}_{z} & Δ {ε}_{y} & {Δ}_{x} \\ Δ {ε}_{z} & 1 & − Δ {ε}_{x} & {Δ}_{y} \\ − Δ {ε}_{y} & Δ {ε}_{x} & 1 & {Δ}_{z} \\ 0 & 0 & 0 & 1\end{matrix} ] ; \qquad ( 14 )$$

where Δₓ represents a positional error deviation of an actual cutting point of the tool relative to an ideal cutting point in the direction of the X-axis, Δ_{y} represents a positional error deviation of the actual cutting point of the tool relative to the ideal cutting point in the direction of the Y-axis, and Δ_{z} represents a positional error deviation of the actual cutting point of the tool relative to the ideal cutting point in the direction of the Z-axis; Δεₓ represents an orientation error deviation of the actual cutting point of the tool relative to the ideal cutting point in the direction of the X-axis, Δε_{y} represents an orientation error deviation of the actual cutting point of the tool relative to the ideal cutting point in the direction of the Y-axis, Δε_{z} represents an orientation error deviation of the actual cutting point of the tool relative to the ideal cutting point in the direction of the Z-axis;

Based on the small-error hypothesis while simultaneously neglecting second-order and higher-order small quantities and eliminating distance brought by three-direction translational translation, substituting formulas (8), (12), and (14) into formula (13) to represent the transformation matrix _{T}^{W}E as:

$$( 15 )$$

$${}_{T}^{W} {E}^{} = [ \begin{matrix}1 & − {ε}_{xx} - {ε}_{xy} - {ε}_{xz} & {ε}_{yx} + {ε}_{yy} + {ε}_{yz} \\ {ε}_{xx} + {ε}_{xy} + {ε}_{xz} & 1 & - ε \text{?} - ε \text{?} - ε \text{?} \\ − {ε}_{yx} - {ε}_{yy} - {ε}_{yx} & {ε}_{xx} + {ε}_{xy} + {ε}_{xz} & 1 \\ 0 & 0 & 0\end{matrix} \text{} \begin{matrix}\begin{matrix}{δ}_{xx} + δ \text{?} + δ \text{?} + \\ z ε \text{?} + z ε \text{?} - z S \text{?}\end{matrix} \\ \begin{matrix}{δ}_{yx} + δ \text{?} + δ \text{?} - z ε \text{?} - \\ z {ε}_{zy} + x ε \text{?} - z S \text{?} - x S \text{?}\end{matrix} \\ δ \text{?} + δ \text{?} + δ \text{?} - x ε \text{?} \\ 1\end{matrix} ] ;$$

$$\text{?} \text{indicates text missing or illegible when filed}$$

Terms corresponding to Δₓ, Δ_{y} and Δ_{z} are extracted from a matrix of formula (15) to obtain the comprehensive error model, expressed as:

$$\{ \begin{matrix}{Δ}_{x} = δ \text{?} + {δ}_{xy} + δ \text{?} + z ε \text{?} + z ε \text{?} + zS \text{?} \\ {Δ}_{y} = δ \text{?} + δ \text{?} + δ \text{?} - z ε \text{?} - z ε \text{?} + x ε \text{?} - zS \text{?} - xS \text{?} \\ {Δ}_{z} = δ \text{?} + δ \text{?} - x ε \text{?}\end{matrix} ; \qquad ( 16 )$$

$$\text{?} \text{indicates text missing or illegible when filed}$$

In the above formulas, Suv represents a perpendicularity error of the v-axis in the direction of the u-axis; the u-axis is one of the X-axis, Y-axis, and Z-axis; and the v-axis is one of the X-axis, Y-axis, and Z-axis.

In a preferred embodiment, based on the actual dimensions and structure of the machine tool, as well as the installation range of the Renishaw XL-80 laser interferometer, the arrangement of measurement points along the X-axis of this CNC machine tool is as shown in Table 1:

TABLE 1
Measurement range of three translational axes

| | X-axis | Y-axis | Z-axis |
|---|---|---|---|
| Measurement (mm) | −640-140 | −660-0 | −500-−100 |

Measurements are taken in the directions of the X-axis, Y-axis, and Z-axis in the space to obtain 18 geometric errors and 3 perpendicularity errors for each of the three directions, measured at intervals of 20 mm. To simplify the complexity of the model, the mean values of the 18 error values measured multiple times along different trajectories of one of the X-axis, Y-axis, and Z-axis are used as standard error values. Each direction (X, Y, Z) has 6 sets of errors, and the coordinates of the measurement points disperse these 6 sets of errors of each direction throughout the space, covering a total of 21 geometric errors at each point in the space.

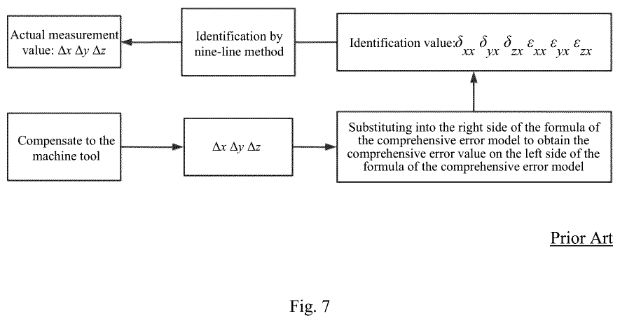

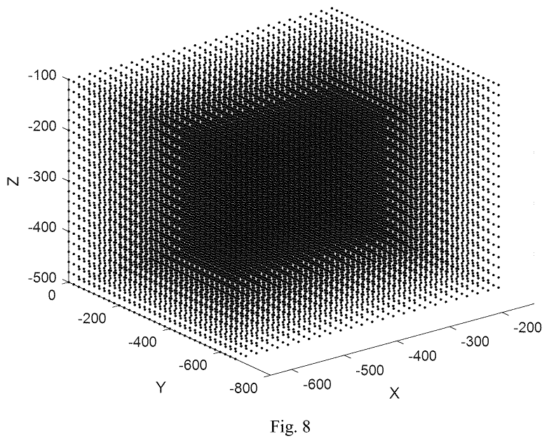

As shown in FIG. 7, this is the general process of identification to compensation using the nine-line method. The ideal error values serve as a reference, and a space equal in size to the measurement space is established using MATLAB. The same distance intervals are divided into a grid, where each grid node, as shown in FIG. 8, represents a measurement point.

Each node contains 21 standard error values, and the comprehensive error model, as expressed in formula (16), is applied to each node. The simulated measurement values are substituted into the right side of the equation set for each point, generating three comprehensive errors (δ_x, δ_y, δ_z) at each node. This establishes an error model that accounts for the topology. Taking the standard error values as a reference, and using the X-axis as an example, the δ_x, δ_y, δ_z values at each node correspond to the left sides of the improved formula (11) and formula (13), as summarized in Table 2.

TABLE 2
Error measurement values and their corresponding terms

| | Δₓ | Δ_{y} | Δ_{z} |
|---|---|---|---|
| Direction of X-axis | δₓₓⁱ | δ_{yx}ⁱ | δ_{zx}ⁱ |
| Direction of Y-axis | δ_{xy}ⁱ | δ_{yy}ⁱ | δ_{zy}ⁱ |
| Direction of Z-axis | δ_{xz}ⁱ | δ_{yz}ⁱ | δ_{zz}ⁱ |

For the numerous variables in the comprehensive error model, all variables are expanded into matrices of the same size as the coordinate space matrix (26×34×21). The corresponding matrices are then used in the operation according to formula (23) to obtain a comprehensive error matrix of the same size (i.e., corresponding to δ_x, δ_y, and δ_z). At this point, each coordinate point uniquely corresponds to a set of values.

In this preferred embodiment, the step of performing optimization based on the comprehensive error model and the preset fitness function to predict the six optimal measurement positions includes the following steps.

Coordinate values of any six measurement points from a plurality of measurement points are combined as an individual to obtain a plurality of individuals. The preset fitness function is introduced to evaluate each of the plurality of individuals; and selecting an individual with a smallest fitness among the plurality of individuals as an optimal individual; where six measurement points corresponding to the optimal individual are selected as the six optimal measurement positions.

Specifically, the optimal individual is determined through the following steps.

(S210) The plurality of individuals is encoded and a population formed by the plurality of individuals is initialized.

(S220) A fitness of each of the plurality of individuals in the population is evaluated using the preset fitness function.

(S230) Whether a current individual among the plurality of individuals has a rank of 6 is determined; if not, a preset large fitness value is randomly assigned to the current individual to mark the current individual as unqualified, and the current individual is returned to the population; otherwise, step (S240) is proceeded.

(S240) Whether the number of iterations reaches a preset number of iterations is determined; if yes, step (S250) is proceeded; and if not, selection, crossover, and mutation operations are performed to generate a new population and step (S220) is returned.

(S250) The current individual is determined as the optimal individual.

Specifically, the preset fitness function is established through the following steps.

A plurality of variables in the measurement space are respectively expanded through a multi-dimensional grid interpolation operation to obtain a plurality of matrices of the same dimension.

The plurality of matrices is calculated based on the comprehensive error model to obtain a plurality of comprehensive error matrices of the same dimension. A mathematical model is constructed based on the plurality of comprehensive error matrices to describe an error distribution throughout the measurement space. The plurality of comprehensive error matrices are respectively corresponding to the plurality of variables

Standard deviations of mean error differences for the plurality of individuals are calculated and a coefficient of variation using the mathematical model is determined as identification results.

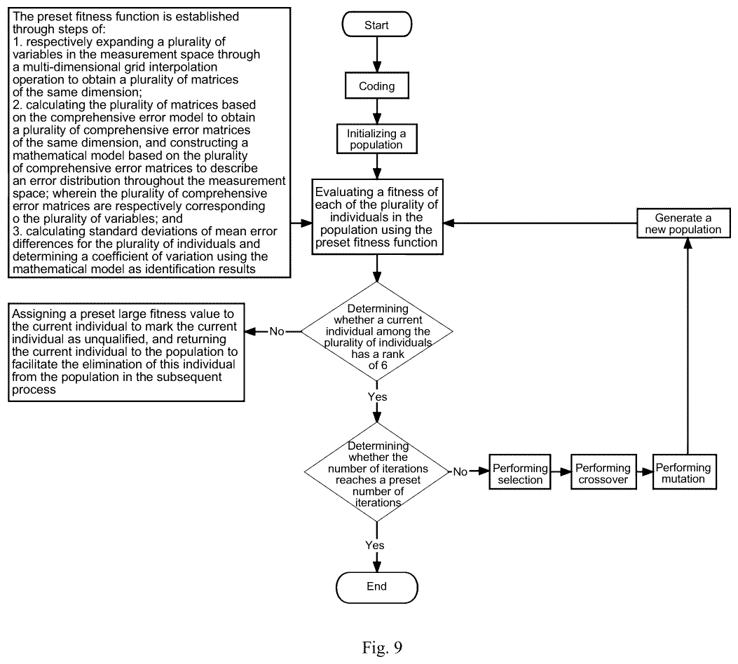

In this preferred embodiment, referring to FIG. 9, the optimization process specifically includes the following steps.

To facilitate the optimization algorithm, the function with the ability to encode and decode individuals is required (in this article, real-number encoding (1-714) is used). The corresponding encoding of the individual is input into the function, and calculations are performed to obtain the corresponding comprehensive errors (δ_{μv}ⁱ) (the column vectors on the left side of formula (12) and formula (14)) and the coordinate matrices (the 6×6 coefficient matrices on the right side of formula (12) and formula (14)). It is determined whether both coordinate matrices have a full rank of 6. If they are, the next calculations proceed; if not, a large fitness value is assigned to this individual, marking it as inferior, and it will be eliminated in the subsequent process.

Taking the direction of the X-axis as an example, calculations are performed using the starting point coordinates, comprehensive errors, and the two sets of coordinate matrices to obtain the two sets of identification errors at the 26 points along the unidirectional axis (the column vectors on the right side of equations (12) and (14)). The first three positioning/straightness errors are collected (angular errors are negligible and difficult to control, having little impact on the overall identification and subsequent compensation processes, so they are not considered here). The value corresponding to the coordinate value is subtracted from the standard error value, the absolute value of the subtracted result is configured to be the scalar for the three sets of error differences (Lₓₓⁱ, L_{yx}ⁱ and L_{zx}ⁱ), expressed as:

$${L}_{μ x}^{i} \{ \begin{matrix}{L}_{μ x}^{1} = \vert {δ}_{μ x 1} − {δ}_{μ x 1}^{′} \vert \\ {L}_{μ x}^{2} = \vert {δ}_{μ x 2} − {δ}_{μ x 2}^{′} \vert \\ ⋯ ⋯ \\ {L}_{μ x}^{26} = \vert {δ}_{μ x 26} − {δ}_{μ x 26}^{′} \vert\end{matrix} ;$$

In the above formula, μ represents the direction of the error deviation (including X-axis, Y-axis and Z-axis), x represents the X-axis, and i represents the i-th measurement point along the measurement path. δ_{μxi} represents the identified error value at the i-th measurement point, δ′_{μxi} represents the measured error value at the i-th measurement point. The mean of the error differences at a single point Lₐⁱ is calculated as follows:

$${L}_{a}^{1} \{ \begin{matrix}{L}_{a}^{1} = ( {L}_{xx}^{1} + {L}_{yx}^{1} + {L}_{zx}^{1} ) / 3 \\ {L}_{a}^{2} = ( {L}_{xx}^{2} + {L}_{yx}^{2} + {L}_{zx}^{2} ) / 3 \\ ⋯ ⋯ \\ {L}_{a}^{26} = ( {L}_{xx}^{26} + {L}_{yx}^{26} + {L}_{zx}^{26} ) / 3\end{matrix} ; \qquad ( 17 )$$

$${L}_{sa} = \frac{1}{26} {\sum }_{i = 1}^{26} {L}_{a}^{1}$$

In the above formula, Lₛₐ represents the mean of the error differences and is as the standard for evaluating the mean size of individual error differences, reflecting the gap between the predicted values and the standard error values in terms of their average size.

To avoid excessive coordinate dispersion among the 26 points along the path, the coefficient of variation cᵥ of Lₛₐ must also be controlled. First, the standard deviation Sₐ is obtained through the following formula:

$${S}_{a} = \sqrt{[ {( {L}_{a}^{1} - {L}_{s a} )}^{2} + {( {L}_{a}^{2} - {L}_{s a} )}^{2} + … + {( {L}_{a}^{26} - {L}_{s a} )}^{2} ] / 26} .$$

Then, the coefficient of variation cᵥ is calculated through the following formula:

$${c}_{v} = \frac{{S}_{a}}{{L}_{sa}} \times 100 \% .$$

At this point, the size of cᵥ is influenced by Sₐ and Lₛₐ, and reflects the degree of variation of the observed values. To prevent the predicted values from being too dispersed, the mean of the error differences Lₛₐ is continuously reduced while cᵥ is also converging, making the predicted values more aligned with the standard error values.

The adaptive genetic algorithm performs a cyclical search in the aforementioned space, continuously converging cᵥ while finding the minimum value of Lₛₐ under a fixed number of iterations, and outputs the encoding of the individuals corresponding to the minimum value of Lₛₐ.

After setting the parameters, the population is initialized, and then it enters the main iteration loop, where selection, crossover, and mutation are performed on the population to generate a new population for the next round of iterations until the preset number of iterations is reached, where the loop stops.

The method for identifying geometric errors of a numerical control (NC) machine tool based on a modified nine-line method proposed in the present disclosure is compared to the original nine-line method as follows.

In this method provided in the present disclosure, with 30 individuals and 10,000 iterations, the optimization result yields the best fitness of 1.42, corresponding to the encoding of individual [692, 168, 492, 444, 63, 379]. After decoding, the corresponding coordinate matrix is:

$$[ \begin{matrix}1 & 0 & 0 & 0 & − 480 & 640 \\ 0 & 1 & 0 & 500 & 0 & − 640 \\ 1 & 0 & 0 & 0 & − 260 & 460 \\ 0 & 0 & 1 & − 420 & 640 & 0 \\ 1 & 0 & 0 & 0 & − 500 & 40 \\ 0 & 0 & 1 & − 360 & 640 & 0\end{matrix} ] . \qquad ( 19 )$$

The corresponding measurement positions start at X=−640 and end at X=−140 on the X-axis to obtain the measurement starting points for the point combinations shown in Table 3.

TABLE 3
Coordinates of starting measurement point for six-point combination

| | | X value | Y value | Z value |
|---|---|---|---|---|
| Point No. | Measurement object | (mm) | (mm) | (mm) |
| P₁ | positioning error δₓₓ¹ | −640 | −640 | −480 |
| P₂ | straightness error δ_{yx}² | −640 | −140 | −500 |
| P₃ | straightness error δₓₓ³ | −640 | −460 | −260 |
| P₄ | positioning error δ_{zx}⁴ | −640 | −420 | −140 |
| P₅ | straightness error δₓₓ⁵ | −640 | −40 | −500 |
| P₆ | positioning error δ_{zx}⁶ | −640 | −360 | −100 |

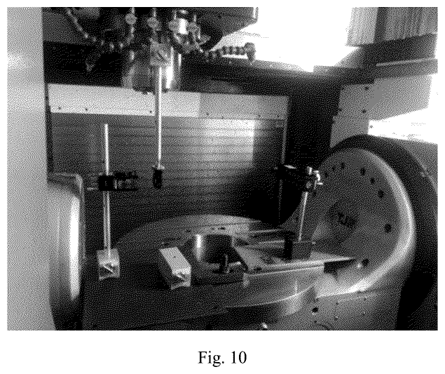

To verify the reliability of the data obtained from the six-point combination, an experiment was conducted using the Renishaw XC-80 laser interferometer for point measurement on the CNC machine tool, as shown in FIG. 10. First, the sensor components were configured to monitor the measurement environment in real-time, with environmental parameters listed in Table 4.

TABLE 4
Experimental environmental parameter values

| Environmental parameter | value |
|---|---|
| Air temperature | 24.2-24.3° C. |
| Air pressure | 1000-1000.4 mbar |
| Air humidity | 94-95% RH |
| Material temperature | 23.8-24° C. |

The coordinates from Table 3 were measured sequentially, setting the starting measurement point at X=−640 mm and the end measurement point at X=−140 mm; the measurements were taken back and forth five times. To reduce the impact of reverse backlash errors, a stroke of 0.05 mm was set; the interval between each measurement point along the path was 20 mm. The error data corresponding to the six points were measured, and the coefficient matrix (formula 19) corresponding to the combinations of the error data and the error data are substituted into the analytical equations given in formula (5) to yield formula (20) to obtain the six error values at each measurement point along the measurement path, as shown in FIG. 10.

The formula 20 is represented by:

$$[ \begin{matrix}{δ}^{1} \text{?} \\ {δ}^{2} \text{?} \\ {δ}^{3} \text{?} \\ {δ}^{4} \text{?} \\ {δ}^{5} \text{?} \\ {δ}^{6} \text{?}\end{matrix} ] [ \begin{matrix}1 & 0 & 0 & 0 & − 480 & 640 \\ 0 & 1 & 0 & 500 & 0 & − 640 \\ 1 & 0 & 0 & 0 & − 260 & 460 \\ 0 & 0 & 1 & − 420 & 640 & 0 \\ 1 & 0 & 0 & 0 & − 500 & 40 \\ 0 & 0 & 1 & − 360 & 640 & 0\end{matrix} ] [ \begin{matrix}δ \text{?} \\ δ \text{?} \\ δ \text{?} \\ ε \text{?} \\ ε \text{?} \\ ε \text{?}\end{matrix} ] . \qquad ( 20 )$$

$$\text{?} \text{indicates text missing or illegible when filed}$$

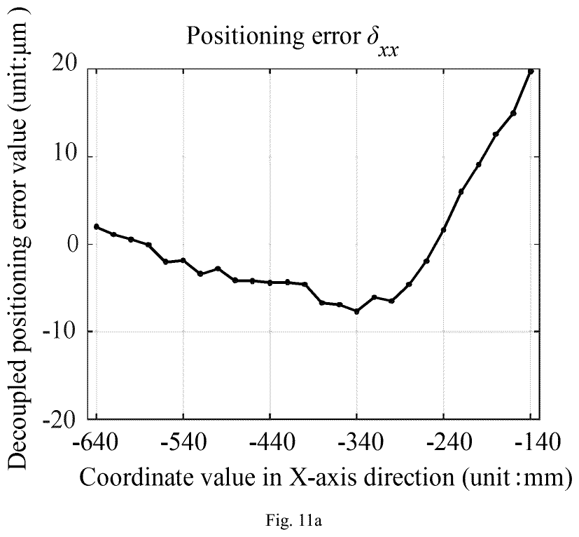

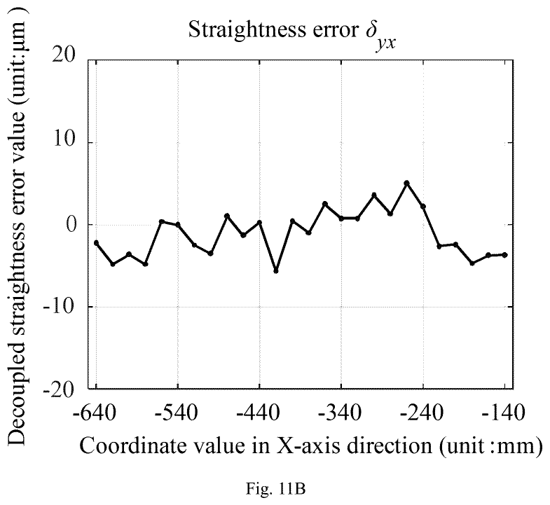

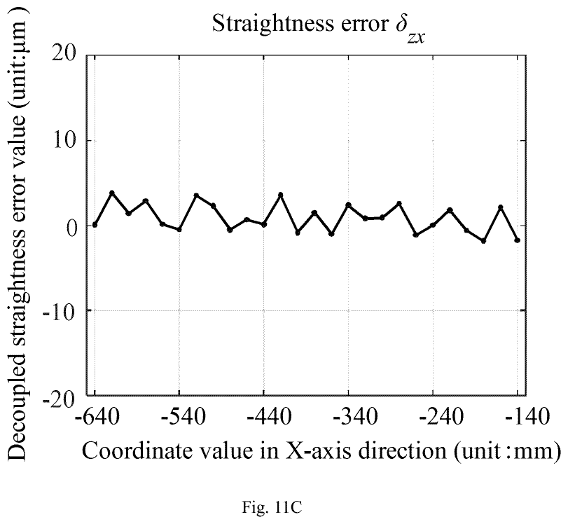

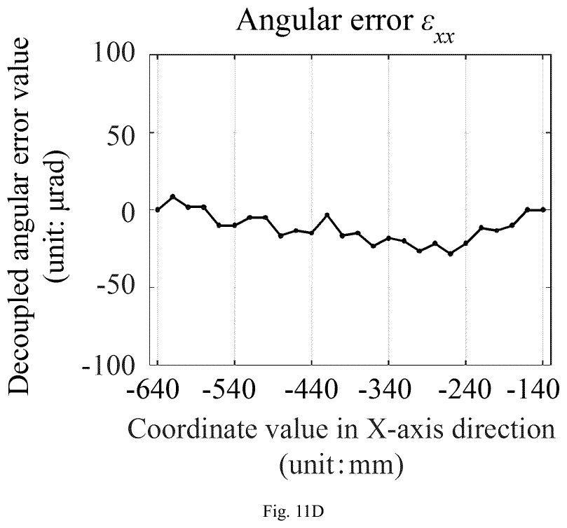

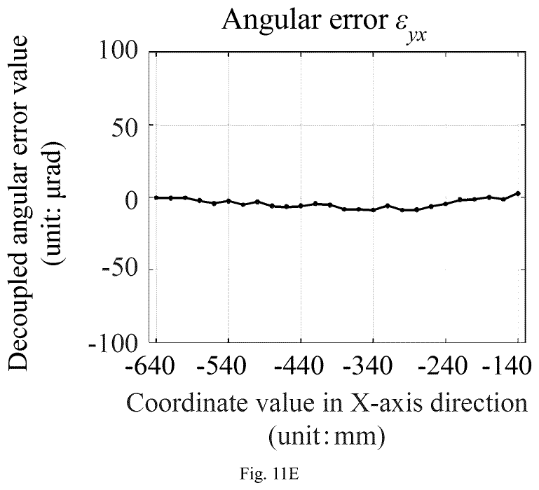

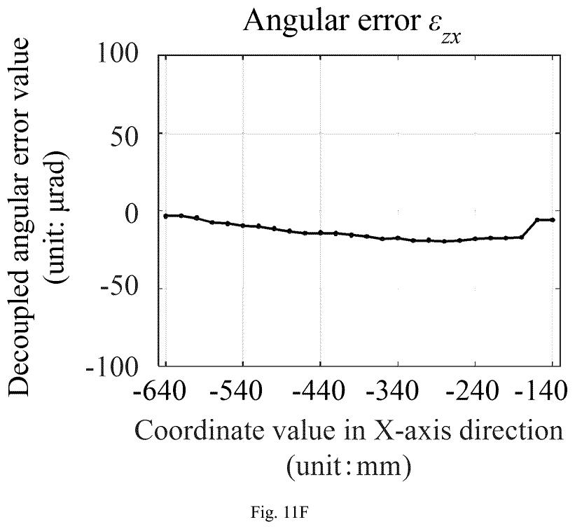

By substituting the measured values (error data) into the left side of the above equation, the six geometric error values were derived and recorded in Table 4, with a line graph illustrated in FIGS. 11A-11F.

The traditional nine-line measurement method was set as a control experiment. In this method, three points were randomly chosen as measurement points, and the corresponding coefficient matrix was used for identification, with the coordinates in Table 5 taken as the starting measurement points.

TABLE 5
Coordinates of starting measurement point for nine-line method

| Point No. | measurement object | X value (mm) | Y value (mm) | Z value (mm) |
|---|---|---|---|---|
| P₁ | positioning error δₓₓ¹ | −640 | −340 | −460 |
| P₁ | straightness error δ_{yx}¹ | −640 | −340 | −460 |
| P₁ | straightness error δ_{zx}¹ | −640 | −340 | −460 |
| P₂ | positioning error δₓₓ² | −640 | −360 | −100 |
| P₂ | straightness error δ_{yx}² | −640 | −360 | −100 |
| P₂ | positioning error δ_{zx}³ | −640 | −20 | −100 |

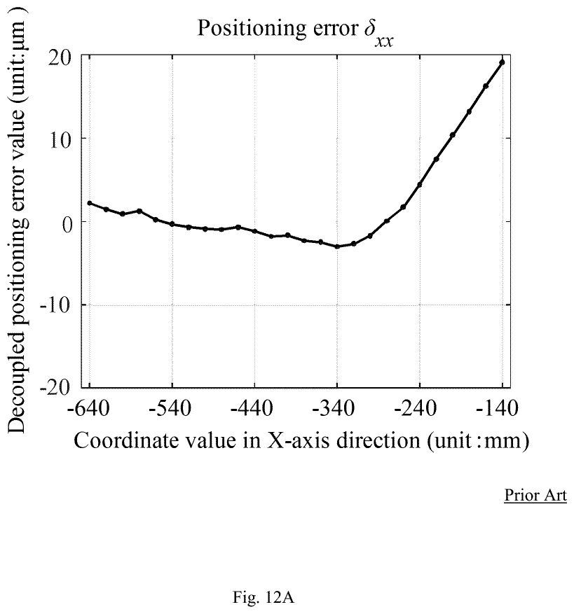

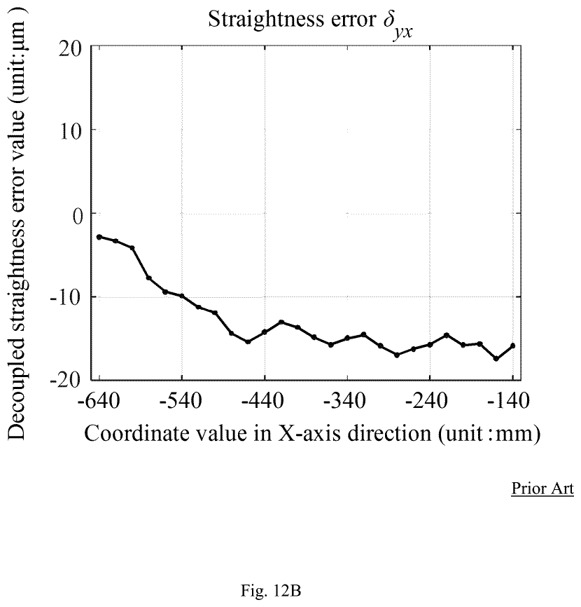

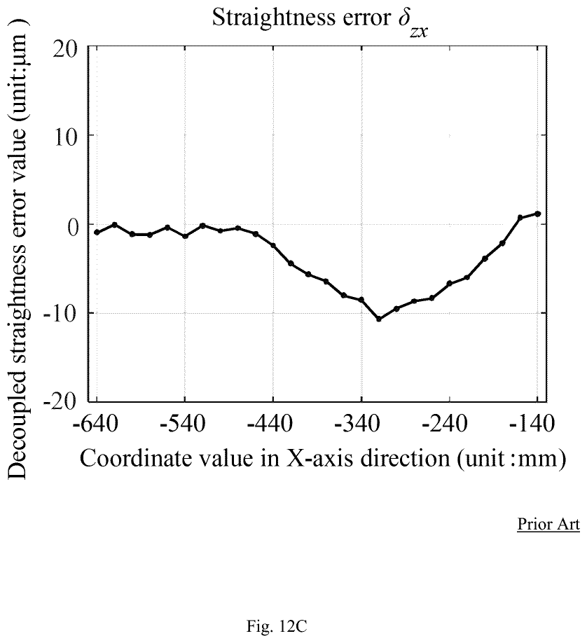

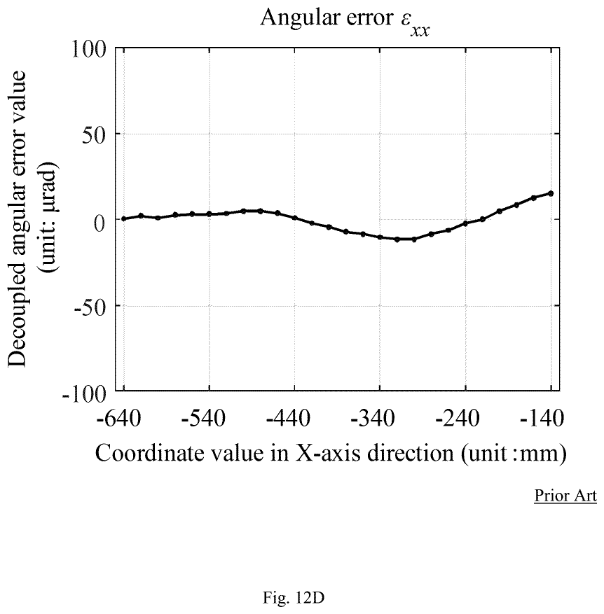

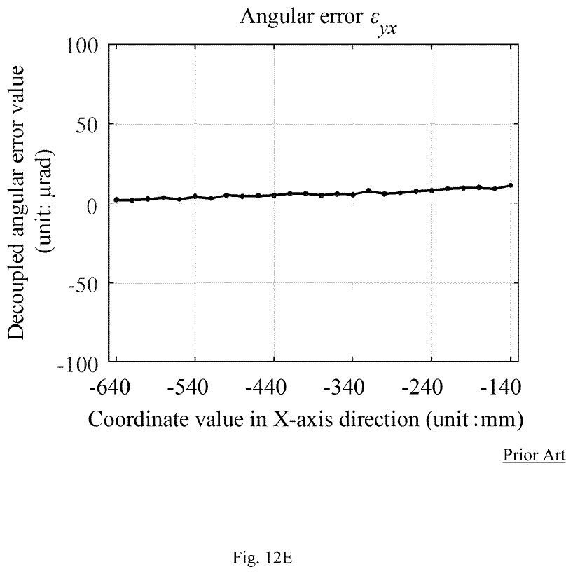

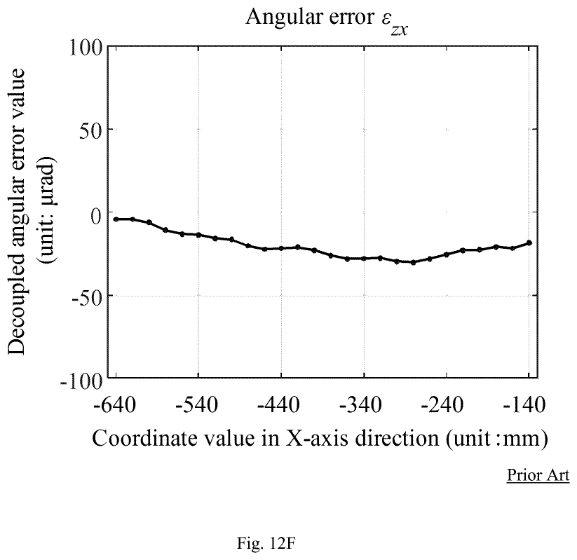

The error data corresponding to each measurement point were measured in sequence. The error data and the coefficient matrix of the coordinate values of the measurement point were substituted into formula (2) to obtain formula (21). Through this, the six types of error values at each measurement point along the path were determined, as illustrated in FIGS. 12A-12F.

The formula (21) is represented by:

$$[ \begin{matrix}{δ}_{xx}^{1} \\ {δ}_{yx}^{1} \\ {δ}_{zx}^{1} \\ {δ}_{xx}^{2} \\ {δ}_{yx}^{2} \\ {δ}_{xx}^{3}\end{matrix} ] = [ \begin{matrix}1 & 0 & 0 & 0 & - 460 & 340 \\ 0 & 1 & 0 & 460 & 0 & - 640 \\ 0 & 0 & 1 & - 340 & 640 & 0 \\ 1 & 0 & 0 & 0 & - 100 & 360 \\ 0 & 1 & 0 & 100 & 0 & - 640 \\ 1 & 0 & 0 & 0 & - 100 & 20\end{matrix} ] [ \begin{matrix}{δ}_{xx} \\ {δ}_{yx} \\ {δ}_{zx} \\ {ε}_{xx} \\ {ε}_{yx} \\ {ε}_{zx}\end{matrix} ] . \qquad ( 21 )$$

By substituting the measurement data (error data) into the left side of this equation, the six types of geometric errors shown below were derived.

The accuracy of identification results of the two methods was assessed by comparing the standard error values of the actual measured errors with the identification results of the two methods (using multiple indicators) as shown in Table 6.

TABLE 6
Error data in actual measurement

| X value | δₓₓ/μm | δ_{yx}/μm | δ_{zx}/μm | εₓₓ/arcsec | ε_{yx}/arcsec | ε_{zx}/arcsec |
|---|---|---|---|---|---|---|
| −640 | 0.4 | 0 | 0 | 6.2 | 1.2 | 4.3 |
| −620 | −0.3 | 0 | 0.25 | 4.8 | 0.6 | 4.3 |
| −600 | −1.6 | 0.3 | 0.55 | 3.3 | 0.1 | 3.9 |
| −580 | −3 | 0 | 0.85 | 2.2 | −0.2 | 3.4 |
| −560 | −4.8 | 0.7 | 1.4 | 1.2 | −0.5 | 2.8 |
| −540 | −5.7 | 1.2 | 1.8 | 0.6 | −0.7 | 2.6 |
| −520 | −6.7 | 1.4 | 2.25 | −0.3 | −1 | 2.1 |
| −500 | −7.3 | 1.4 | 2.25 | −0.9 | −1.2 | 1.7 |
| −480 | −8.7 | 1.1 | 2.3 | −1.5 | −1.5 | 1.4 |
| −460 | −9.2 | 1.3 | 1.8 | −2.0 | −1.7 | 1 |
| −440 | −9.5 | 1.9 | 2.25 | −2.3 | −1.9 | 0.9 |
| −420 | −10 | 2.1 | 2.1 | −3.0 | −2.4 | 0.8 |
| −400 | −10.5 | 2.1 | 2.4 | −3.2 | −2.7 | 0.7 |
| −380 | −12.2 | 2.1 | 2.15 | −3.8 | −3.2 | 0.5 |
| −360 | −13.2 | 2.5 | 2.9 | −4.2 | −3.7 | 0.5 |
| −340 | −13.6 | 2.9 | 4.05 | −4.4 | −4.1 | 0.5 |
| −320 | −13.4 | 3 | 5 | −4.4 | −4.4 | 0.6 |
| −300 | −13 | 3.4 | 5.7 | −4.2 | −4.4 | 0.4 |
| −280 | −11.5 | 3.1 | 5.65 | −3.8 | −4.1 | 0 |
| −260 | −9.2 | 3.2 | 5.95 | −3.2 | −3.7 | −0.1 |
| −240 | −5.6 | 3 | 5.65 | −2.6 | −3.2 | −0.1 |

TABLE 7
Evaluation of identification values for two methods

| | | | Standard | |
|---|---|---|---|---|
| | | mean | deviation | Range |
| Error item | Method | (unit: μm) | (unit: μm) | (unit: μm) |
| Positioning | actual measurement | −5.22 | 7.52 | 29.8 |
| error δₓₓ | nine-line method | 2.23 | 5.9 | 22.1 |
| | method provided in | −0.19 | 7 | 27.4 |
| | the present disclosure | | | |
| Straightness | actual measurement | 1.65 | 1.12 | 5.1 |
| error in | nine-line method | −12.88 | 4.12 | 14.53 |
| direction of | method provided in | −1.1 | 2.78 | 10.65 |
| Y-axis δ_{yx} | the present disclosure | | | |
| Straightness | actual measurement | 2.68 | 1.83 | 5.95 |
| error in | nine-line method | −3.73 | 3.56 | 11.8 |
| direction of | method provided in | 0.86 | 1.63 | 5.6 |
| Z-axis δ_{zx} | the present disclosure | | | |

TABLE 8
Root Mean Square Error (RMSE) with Actual Value as Reference

| | | Straightness | Straightness |
|---|---|---|---|
| | | error in | error in |
| | Positioning | direction | direction |
| | error | of Y-axis | of Z-axis |
| | δₓₓ | δ_{yx} | δ_{zx} |
| nine-line method | 6.4659 | 15.3399 | 8.2532 |
| method provided in | 4.0529 | 3.5059 | 3.1199 |
| the present disclosure | | | |

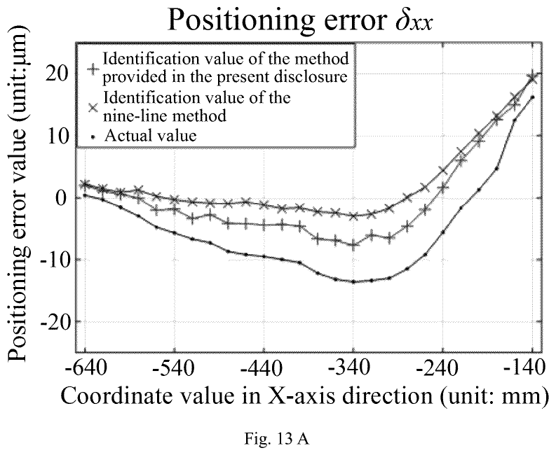

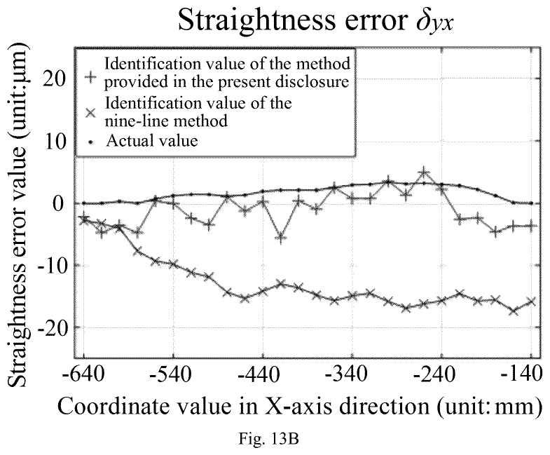

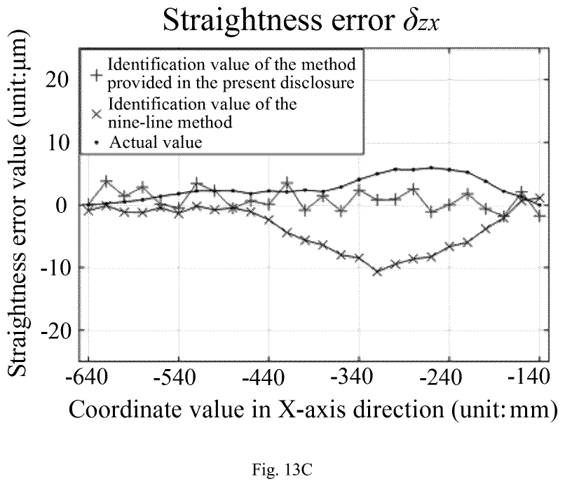

By comparing identification results of the method provided in this present disclosure and the traditional method with the indicators of actual measured values, as shown in FIGS. 13A-13C and Table 7, the method provided in this present disclosure demonstrates error values for mean, standard deviation, and range that are closer to those of actual measurements compared to the traditional method. Table 8 further shows that the method provided in this present disclosure has a lower root mean square error, indicating a higher reliability of the identification results for reflecting actual measurements. Angular error holds different geometric significance in actual measurements compared to the geometric quantities described by the nine-line identification model and is minimal. Its identification results are difficult to control and have little impact on subsequent compensation. Here, only the three significant linear errors affecting practical compensation are considered.

The conclusion of the present disclosure is as follows.

1. The method provided in this present disclosure addresses limited trajectory of the “nine-line eighteen measurements”. It is difficult for “nine-line eighteen measurements” to describe the overall spatial errors. By employing an analytical principle based on the nine-line method, the method provided in this present disclosure performs “eighteen lines and eighteen measurements,” dispersing multiple error measurements from a single point across several points. This not only extracts a broader range of error information, enhancing the generalizability of the identification results for the measurement space, but also reduces the impact of repeated positioning errors.

2. A comprehensive error model for the topological structure of the translational axis of a dual rotary five-axis NC machine tool was established through homogeneous coordinate transformation based on multibody system theory. Leveraging this model, an error field was constructed within the measurement range using computer simulation. In this space of the error field, an adaptive genetic algorithm searches for various combinations of coordinate points and predicts identification results. This method provided in this present disclosure can partially address the issues of the machine tool's topological structure overlooked by the traditional nine-line method and deviations of the identification results influenced by the coordinate values of the measurement point, while also automatically filtering out singular matrices that have no solutions.

3. Comparing the identification results of the method provided by the present disclosure and nine-line method with actual measurement outcomes reveals that the method provided by the present disclosure exhibits stronger adherence to linear errors than the traditional method. When used to describe linear errors within geometric errors, the method provided by the present disclosure demonstrates a higher level of reliability.

The present disclosure also provides a device for identifying geometric errors of a NC machine tool based on a modified nine-line method. The device includes a first construction module, a second construction module and a simulation and identification module.

The first construction module is configured for superimposing motion errors between a plurality of rigid bodies of the NC machine tool to construct a comprehensive error model based on multibody system kinematics theory and a topological structure of the NC machine tool; and performing optimization based on the comprehensive error model and a preset fitness function to predict six optimal measurement positions.

The second construction module is configured for establishing six linear measurement trajectories respectively at the six optimal measurement positions; where the six linear measurement trajectories are each parallel to one of an X-axis, a Y-axis, and a Z-axis; and measuring a error term for each of the six linear measurement trajectories to establish a first equation set having six first equations.

The simulation and identification module is configured for performing geometric error simulation and identification for the NC machine tool based on the first equation set.

Although the description of this present disclosure has been quite detailed, particularly regarding several specific embodiments, it is not intended to limit the present disclosure to any of these details or embodiments. Rather, it should be understood that the present disclosure encompasses a broad interpretation of the claims, considering the prior art, in order to effectively cover the intended scope of the present disclosure. Additionally, the embodiments provided above are foreseeable implementations intended to provide useful descriptions, and any non-substantial modifications to the present disclosure that are not currently anticipated may still be regarded as equivalent modifications of the present disclosure.

The above descriptions are merely preferred embodiments of the present disclosure; the present disclosure is not limited to the aforementioned implementations. Any modifications or variations that achieve the same technical effect as the present disclosure using similar means should fall within the protection scope of this present disclosure. Within the scope of protection of this present disclosure, various different modifications and changes can be made to its technical solutions and/or implementations.

What is claimed is:

1. A method for identifying geometric errors of a numerical control (NC) machine tool based on a modified nine-line method, comprising:
(S110) based on multibody system kinematics theory and a topological structure of the NC machine tool, constructing a comprehensive error model by superimposing motion errors between a plurality of rigid bodies of the NC machine tool; and
performing optimization based on the comprehensive error model and a preset fitness function to predict six optimal measurement positions;
(S120) establishing six linear measurement trajectories respectively at the six optimal measurement positions; wherein the six linear measurement trajectories are each parallel to one of an X-axis, a Y-axis, and a Z-axis; and measuring an error term for each of the six linear measurement trajectories to establish a first equation set having six first equations; and
(S130) performing geometric error simulation and identification for the NC machine tool based on the first equation set;
wherein the step (S120) comprises:
densifying an original measurement trajectory, wherein each point in a measurement space is configured to correspond to an error vector represented by formula (3); a total of six second equation sets are obtained in a case that six points respectively on six parallel lines are taken, and the formula (3) is one of the six second equation sets corresponding to an i-th point, represented by:
$$\{ \begin{matrix}Δ {X}^{i} = {δ}_{xx}^{i} - {ε}_{zx}^{i} {y}_{i} + {ε}_{yx}^{i} {z}_{i} \\ Δ {Y}^{i} = {δ}_{yx}^{i} - {ε}_{xx}^{i} {z}_{i} + {ε}_{zx}^{i} {x}_{i} \\ Δ {Z}^{i} = {δ}_{zx}^{i} - {ε}_{yx}^{i} {x}_{i} + {ε}_{xx}^{i} {y}_{i}\end{matrix} ; \qquad ( 3 )$$
wherein i=1, 2, . . . , 6; and
extracting one equation from each of the six second equation sets followed by combination to construct a third equation set; wherein a unique solution exists for the third equation set provided that the third equation set comprises six error terms corresponding to the six linear measurement trajectories, and a coordinate matrix of the formula (3) maintains full rank;
through MATLAB-assisted calculation, it is determined that the number of the third equation set satisfying requirements is 120;
selecting two from 120 third equation sets, respectively represented by formula (4) and formula (6):
$$\{ \begin{matrix}{δ}_{xx}^{1} = {δ}_{xx} - {ε}_{zx} {y}_{1} + {ε}_{yx} {z}_{1} \\ {δ}_{yx}^{2} = {δ}_{yx} - {ε}_{xx} {z}_{2} + {ε}_{zx} {x}_{2} \\ {δ}_{xx}^{3} = {δ}_{zx} - {ε}_{zx} {y}_{3} + {ε}_{yx} {z}_{3} \\ {δ}_{zx}^{4} = {δ}_{zx} - {ε}_{yx} {x}_{4} + {ε}_{xx} {y}_{4} \\ {δ}_{xx}^{5} = {δ}_{xx} - {ε}_{zx} {y}_{5} + {ε}_{yz} {z}_{5} \\ {δ}_{zx}^{6} = {δ}_{xx} - {ε}_{yx} {x}_{6} + {ε}_{xx} {y}_{6}\end{matrix} , \qquad ( 4 )$$
$$and$$
$$\{ \begin{matrix}{δ}_{xx}^{1} = {δ}_{xx} - {ε}_{zx} {y}_{1} + {ε}_{yx} {z}_{1} \\ {δ}_{yx}^{2} = {δ}_{yz} - {ε}_{xx} {z}_{2} + {ε}_{zx} {x}_{2} \\ {δ}_{zz}^{3} = {δ}_{zz} - {ε}_{yx} {x}_{3} + {ε}_{xx} {y}_{3} \\ {δ}_{xx}^{4} = {δ}_{xx} - {ε}_{zx} {y}_{4} + {ε}_{yz} {z}_{4} \\ {δ}_{yz}^{5} = {δ}_{yz} - {ε}_{xx} {z}_{5} + {ε}_{zz} {x}_{5} \\ {δ}_{xx}^{6} = {δ}_{xx} - {ε}_{zz} {y}_{6} + {ε}_{yx} {z}_{6}\end{matrix} ; \qquad ( 6 )$$
rewriting the formula (4) into formula (5) in a matrix form, represented by:
$$[ \begin{matrix}{δ}_{xx}^{1} \\ {δ}_{yx}^{2} \\ {δ}_{xx}^{3} \\ {δ}_{zx}^{4} \\ {δ}_{xx}^{5} \\ {δ}_{zx}^{6}\end{matrix} ] = [ \begin{matrix}1 & 0 & 0 & 0 & {z}_{1} & - {y}_{1} \\ 0 & 1 & 0 & - {z}_{2} & 0 & {x}_{2} \\ 1 & 0 & 0 & 0 & {z}_{3} & - {y}_{3} \\ 0 & 0 & 1 & {y}_{4} & - {x}_{4} & 0 \\ 1 & 0 & 0 & 0 & {z}_{5} & - {y}_{5} \\ 0 & 0 & 1 & {y}_{6} & - {x}_{6} & 0\end{matrix} ] [ \begin{matrix}{δ}_{xx} \\ {δ}_{yx} \\ {δ}_{zx} \\ {ε}_{xx} \\ {ε}_{yx} \\ {ε}_{zx}\end{matrix} ] ; \qquad ( 5 )$$
wherein the six linear measurement trajectories consist of a first trajectory, a second trajectory, a third trajectory, a fourth trajectory, a fifth trajectory, and a sixth trajectory; δₓₓ¹ indicates a positioning error along the X-axis on the first trajectory; δ_{yx}² indicates a straightness error of the X-axis in a direction of the Y-axis on the second trajectory; δₓₓ³ indicates a positioning error along the X-axis on the third trajectory; δ_{zx}⁴ indicates a straightness error of the X-axis in a direction of the Z-axis on the fourth trajectory; δₓₓ⁵ indicates a positioning error of the X-axis on the fifth trajectory; and δ_{zx}⁶ indicates a straightness error of the X-axis in the direction of the Z-axis on the sixth trajectory;
substituting measured values into a left side of the formula (5) and corresponding coordinate values into a right side of the formula (5) to solve the six error terms to be solved;
rewriting the formula (6) into formula (7) in a matrix form, expressed by:
$$[ \begin{matrix}{δ}_{xx}^{1} \\ {δ}_{yx}^{2} \\ {δ}_{xx}^{3} \\ {δ}_{zx}^{4} \\ {δ}_{xx}^{5} \\ {δ}_{zx}^{6}\end{matrix} ] = [ \begin{matrix}1 & 0 & 0 & 0 & {z}_{1} & - {y}_{1} \\ 0 & 1 & 0 & - {z}_{2} & 0 & {x}_{2} \\ 0 & 0 & 1 & {y}_{3} & - {x}_{1} & 0 \\ 1 & 0 & 0 & 0 & {z}_{4} & - {y}_{4} \\ 0 & 1 & 0 & - {z}_{5} & 0 & {x}_{5} \\ 1 & 0 & 0 & 0 & {z}_{6} & - {y}_{6}\end{matrix} ] [ \begin{matrix}{δ}_{xx} \\ {δ}_{yx} \\ {δ}_{zx} \\ {ε}_{xx} \\ {ε}_{yx} \\ {ε}_{zx}\end{matrix} ] ; \qquad ( 7 )$$
and
wherein δᵤᵥ represents a translation error of a v-axis in a direction of a u-axis, wherein the translation error comprises positioning error and straightness error; εᵤᵥ represents an angular error of the v-axis in the direction of the u-axis, wherein the u-axis is one of the X-axis, Y-axis, and Z-axis; and the v-axis is one of the X-axis, Y-axis, and Z-axis.

2. The method of claim 1, wherein the plurality of rigid bodies comprises an X-axis platform, a Y-axis platform, a Z-axis platform, a spindle, a tool, and a workpiece; and
the step of constructing the comprehensive error model by superimposing motion errors between the plurality of rigid bodies comprises:
creating a reference coordinate system R on the NC machine tool in an initial state; creating a local coordinate system X on the X-axis platform; creating a local coordinate system Y on the Y-axis platform; creating a local coordinate system Z on the Z-axis platform; creating a local coordinate system S on the spindle; creating a local coordinate system T on the tool; creating a local coordinate system W on the workpiece;
wherein X-axis, Y-axis and Z-axis directions of each of the local coordinate system X, the local coordinate system Y, the local coordinate system Z, the local coordinate system S, the local coordinate system T and the local coordinate system W are the same as X-axis, Y-axis and Z-axis directions of the reference coordinate system R, respectively; the Z-axis platform is directly connected to the spindle and the tool without relative motion, such that _{S}^{Z}T=I, wherein _{S}^{Z}T represents a homogeneous transformation matrix from the local coordinate system Z to the local coordinate system S, and I represents identity matrix; the spindle is directly connected to the tool, such that _{T}^{S}T=I, wherein _{T}^{S}T represents a homogeneous transformation matrix from the local coordinate system S to the local coordinate system T; and the workpiece is directly connected to the NC machine tool, such that _{R}^{W}T=I, wherein _{R}^{W}T represents a homogeneous transformation matrix from the local coordinate system W to the reference coordinate system R;
in a case that the NC machine tool respectively moves x in the direction of the X-axis, y in the direction of the Y-axis and z in the direction of the Z-axis in an error-free state, a homogeneous transformation matrix from the local coordinate system W to the local coordinate system T is represented by:
$${T}_{W}^{} {T}^{i} = {R}_{W}^{} {T}^{s} \cdot {T}_{R}^{} {T}^{i} = {R}_{W}^{} {T}^{i} \cdot {Y}_{R}^{} {T}^{i} \cdot {X}_{Y}^{} {T}^{i} \cdot {Z}_{X}^{} {T}^{i} \cdot {S}_{Z}^{} {T}^{s} \cdot {T}_{S}^{} {T}^{i} = [ \begin{matrix}1 & 0 & 0 & x \\ 0 & 1 & 0 & y \\ 0 & 0 & 1 & z \\ 0 & 0 & 0 & 1\end{matrix} ] ; \qquad ( 8 )$$
wherein i represents a corresponding matrix in the error-free state; ₚ^{q}Tⁱ represents a homogeneous transformation matrix from coordinate system q to coordinate system p in the error-free state; and p and q each are one of the reference coordinate system R, the local coordinate system X, the local coordinate system Y, the local coordinate system Z, the local coordinate system S, the local coordinate system T and the local coordinate system W;
in a case that the NC machine tool respectively moves x in the direction of the X-axis, y in the direction of the Y-axis and z in the direction of the Z-axis in an error state, based on small-error hypothesis and homogeneous coordinate transformation, a homogeneous transformation matrix from the local coordinate system W to the local coordinate system T is represented by:
$${T}_{W}^{} {T}^{e} = {R}_{W}^{} {T}^{e} \cdot {T}_{R}^{} {T}^{e} = {R}_{W}^{} {T}^{e} \cdot {Y}_{R}^{} {T}^{e} \cdot {X}_{Y}^{} {T}^{e} \cdot {Z}_{X}^{} {T}^{e} \cdot {S}_{Z}^{} {T}^{e} \cdot {T}_{S}^{} {T}^{e} ; \qquad ( 12 )$$
wherein e represents a corresponding matrix in the error state; ₚ^{q}T^{e} represents a homogeneous transformation matrix from coordinate system q to coordinate system p in the error state; each of p and q is one of the reference coordinate system R, the local coordinate system X, the local coordinate system Y, the local coordinate system Z, the local coordinate system S, the local coordinate system T and the local coordinate system W; and the homogeneous transformation matrix _{T}^{W}T^{e} is configured to be derived from multiplication of the homogeneous transformation matrix _{T}^{W}Tⁱ by a transformation matrix _{T}^{W}E from the local coordinate system W to the local coordinate system T in the error state, expressed as:
$${T}_{W}^{} {T}^{e} = {T}_{W}^{} {T}^{i} {T}_{W}^{} E ; \qquad ( 13 )$$
based on the small-error hypothesis, the transformation matrix from the local coordinate system W to the local coordinate system T is represented by:
$${T}_{W}^{} E [ \begin{matrix}1 & - {Δε}_{z} & {Δε}_{y} & {Δ}_{x} \\ {Δε}_{z} & 1 & - {Δε}_{x} & {Δ}_{y} \\ - {Δε}_{y} & {Δε}_{x} & 1 & {Δ}_{z} \\ 0 & 0 & 0 & 1\end{matrix} ] ; \qquad ( 14 )$$
wherein Δₓ represents a positional error deviation of an actual cutting point of the tool relative to an ideal cutting point in the direction of the X-axis, Δ_{y} represents a positional error deviation of the actual cutting point of the tool relative to the ideal cutting point in the direction of the Y-axis, and Δ_{z} represents a positional error deviation of the actual cutting point of the tool relative to the ideal cutting point in the direction of the Z-axis; Δεₓ represents an orientation error deviation of the actual cutting point of the tool relative to the ideal cutting point in the direction of the X-axis, Δε_{y} represents an orientation error deviation of the actual cutting point of the tool relative to the ideal cutting point in the direction of the Y-axis, and Δε_{z} represents an orientation error deviation of the actual cutting point of the tool relative to the ideal cutting point in the direction of the Z-axis;
substituting formulas (8), (12), and (14) into formula (13) based on the small-error hypothesis while simultaneously neglecting second-order and higher-order small quantities and eliminating distances brought by three-directional translations, such that the transformation matrix _{T}^{W}E is expressed as:
$${T}_{W}^{} E [ \begin{matrix}1 & - ε \text{?} - ε \text{?} - ε \text{?} & ε \text{?} + ε \text{?} + ε \text{?} & δ \text{?} + δ \text{?} + δ \text{?} + z ε \text{?} + z ε \text{?} - zS \text{?} \\ ε \text{?} + ε \text{?} + ε \text{?} & 1 & - ε \text{?} - ε \text{?} - ε \text{?} & δ \text{?} + δ \text{?} + δ \text{?} - z ε \text{?} - z ε \text{?} + x \text{?} - zS \text{?} - xS \text{?} \\ - ε \text{?} - ε \text{?} - ε \text{?} & ε \text{?} + ε \text{?} + ε \text{?} & 1 & δ \text{?} + δ \text{?} + δ \text{?} - x ε \text{?} \\ 0 & 0 & 0 & 1\end{matrix} ] ; \qquad ( 15 )$$
$$\text{?} \text{indicates text missing or illegible when filed}$$
extracting terms corresponding to Δₓ, Δ_{y}, and Δ_{z} from a matrix of formula (15) to obtain the comprehensive error model, expressed as:
$$\{ \begin{matrix}{Δ}_{x} = δ \text{?} + δ \text{?} + δ \text{?} + z ε \text{?} + z ε \text{?} - zS \text{?} \\ {Δ}_{y} = δ \text{?} + δ \text{?} + δ \text{?} - z ε \text{?} - z ε \text{?} + x ε \text{?} - zS \text{?} - xS \text{?} \\ {Δ}_{z} = δ \text{?} + δ \text{?} + δ \text{?} - x ε \text{?}\end{matrix} ; \qquad ( 16 )$$
$$\text{?} \text{indicates text missing or illegible when filed}$$
wherein Sᵤᵥ represents a perpendicularity error of the v-axis in the direction of the u-axis; the u-axis is one of the X-axis, Y-axis, and Z-axis; and the v-axis is one of the X-axis, Y-axis, and Z-axis.

3. The method of claim 1, wherein the step of performing optimization based on the comprehensive error model and the preset fitness function to predict the six optimal measurement positions comprises:
combining coordinate values of any six measurement points from a plurality of measurement points as an individual to obtain a plurality of individuals; and
introducing the preset fitness function to evaluate each of the plurality of individuals; and selecting an individual with a smallest fitness among the plurality of individuals as an optimal individual; wherein six measurement points corresponding to the optimal individual are selected as the six optimal measurement positions.

4. The method of claim 3, wherein the optimal individual is determined through steps of:
(S210) encoding a plurality of individuals, and initializing a population formed by the plurality of individuals;
(S220) evaluating a fitness of each of the plurality of individuals in the population using the preset fitness function;
(S230) determining whether a current individual among the plurality of individuals has a rank of 6; if not, randomly assigning a preset large fitness value to the current individual to mark the current individual as unqualified, and returning the current individual to the population; otherwise, proceeding to step (S240);
(S240) determining whether the number of iterations reaches a preset number of iterations; if yes, proceeding to step (S250); and if not, performing selection, crossover, and mutation operations to generate a new population and returning to step (S220); and
(S250) determining the current individual as the optimal individual.

5. The method of claim 4, wherein the preset fitness function is established through steps of:
respectively expanding a plurality of variables in the measurement space through a multi-dimensional grid interpolation operation to obtain a plurality of matrices of the same dimension;
calculating the plurality of matrices based on the comprehensive error model to obtain a plurality of comprehensive error matrices of the same dimension, and constructing a mathematical model based on the plurality of comprehensive error matrices to describe an error distribution throughout the measurement space; wherein the plurality of comprehensive error matrices are respectively corresponding to the plurality of variables; and
calculating standard deviations of mean error differences for the plurality of individuals and determining a coefficient of variation using the mathematical model as identification results.

6. A device for identifying geometric errors of a NC machine tool based on a modified nine-line method, comprising:
a first construction module;
a second construction module;
a simulation and identification module;
wherein the first construction module is configured for constructing a comprehensive error model by superimposing motion errors between a plurality of rigid bodies of the NC machine tool based on multibody system kinematics theory and a topological structure of the NC machine tool; and performing optimization based on the comprehensive error model and a preset fitness function to predict six optimal measurement positions;
the second construction module is configured for establishing six linear measurement trajectories respectively at the six optimal measurement positions; wherein the six linear measurement trajectories are each parallel to one of an X-axis, a Y-axis, and a Z-axis; and measuring an error term for each of the six linear measurement trajectories to establish a first equation set having six first equations; and;
the simulation and identification module is configured for a step of:
performing geometric error simulation and identification for the NC machine tool based on the first equation set through steps of:
densifying an original measurement trajectory, wherein each point in a measurement space is configured to correspond to an error vector represented by formula (3); a total of six second equation sets are obtained in a case that six points respectively on six parallel lines are taken, and the formula (3) is one of the six second equation sets corresponding to an i-th point, represented by:
$$\{ \begin{matrix}Δ {X}^{i} = {δ}_{xx}^{i} - {ε}_{zx}^{i} {y}_{i} + {ε}_{yx}^{i} {z}_{i} \\ Δ {Y}^{i} = {δ}_{yx}^{i} - {ε}_{xx}^{i} {z}_{i} + {ε}_{zx}^{i} {x}_{i} \\ Δ {Z}^{i} = {δ}_{zx}^{i} - {ε}_{yx}^{i} {x}_{i} + {ε}_{xx}^{i} {y}_{i}\end{matrix} ; \qquad ( 3 )$$
wherein i=1, 2, . . . , 6; and
extracting one equation from each of the six second equation sets followed by combination to construct a third equation set; wherein a unique solution exists for the third equation set provided that the third equation set comprises six error terms corresponding to the six linear measurement trajectories, and a coordinate matrix of the formula (3) maintains full rank;
through MATLAB-assisted calculation, it is determined that the number of the third equation set satisfying requirements is 120;
selecting two from 120 third equation sets, respectively represented by formula (4) and formula (6):
$$\{ \begin{matrix}{δ}_{xx}^{1} = {δ}_{xx} - {ε}_{zx} {y}_{1} + {ε}_{yx} {z}_{1} \\ {δ}_{yx}^{2} = {δ}_{yx} - {ε}_{xx} {z}_{2} + {ε}_{zx} {x}_{2} \\ {δ}_{xx}^{3} = {δ}_{zx} - {ε}_{zz} {y}_{3} + {ε}_{yz} {z}_{3} \\ {δ}_{zx}^{4} = {δ}_{zx} - {ε}_{yx} {x}_{4} + {ε}_{xx} {z}_{4} \\ {δ}_{xx}^{5} = {δ}_{xx} - {ε}_{zx} {y}_{5} + {ε}_{yz} {z}_{5} \\ {δ}_{zx}^{6} = {δ}_{zx} - {ε}_{yz} {x}_{6} + {ε}_{xx} {y}_{6}\end{matrix} , \qquad ( 4 )$$
$$and$$
$$\{ \begin{matrix}{δ}_{xx}^{1} = {δ}_{xx} - {ε}_{zx} {y}_{1} + {ε}_{yx} {z}_{1} \\ {δ}_{yx}^{2} = {δ}_{yz} - {ε}_{xx} {z}_{2} + {ε}_{zx} {x}_{2} \\ {δ}_{zx}^{3} = {δ}_{zz} - {ε}_{yx} {x}_{3} + {ε}_{xx} {y}_{3} \\ {δ}_{xx}^{4} = {δ}_{xx} - {ε}_{zx} {y}_{4} + {ε}_{yx} {z}_{4} \\ {δ}_{yx}^{5} = {δ}_{yz} - {ε}_{xx} {z}_{5} + {ε}_{zz} {x}_{5} \\ {δ}_{xx}^{6} = {δ}_{xx} - {ε}_{zz} {y}_{6} + {ε}_{yz} {z}_{6}\end{matrix} ; \qquad ( 6 )$$
rewriting the formula (4) into formula (5) in a matrix form, represented by:
$$[ \begin{matrix}{δ}_{xx}^{1} \\ {δ}_{yx}^{2} \\ {δ}_{xx}^{3} \\ {δ}_{zx}^{4} \\ {δ}_{xx}^{5} \\ {δ}_{zx}^{6}\end{matrix} ] = [ \begin{matrix}1 & 0 & 0 & 0 & {z}_{1} & - {y}_{1} \\ 0 & 1 & 0 & - {z}_{2} & 0 & {x}_{2} \\ 1 & 0 & 0 & 0 & {z}_{3} & - {y}_{3} \\ 0 & 0 & 1 & {y}_{4} & - {x}_{4} & 0 \\ 1 & 0 & 0 & 0 & {z}_{5} & - {y}_{5} \\ 0 & 0 & 0 & {y}_{6} & - {x}_{6} & 0\end{matrix} ] [ \begin{matrix}{δ}_{xx} \\ {δ}_{yx} \\ {δ}_{zx} \\ {ε}_{xx} \\ {ε}_{yx} \\ {ε}_{zx}\end{matrix} ] ; \qquad ( 5 )$$
wherein the six linear measurement trajectories consist of a first trajectory, a second trajectory, a third trajectory, a fourth trajectory, a fifth trajectory, and a sixth trajectory; δₓₓ¹ indicates a positioning error along the X-axis on the first trajectory; δ_{yx}² indicates a straightness error of the X-axis in a direction of the Y-axis on the second trajectory; δₓₓ³ indicates a positioning error along the X-axis on the third trajectory; δ_{zx}⁴ indicates a straightness error of the X-axis in a direction of the Z-axis on the fourth trajectory; δₓₓ⁵ indicates a positioning error of the X-axis on the fifth trajectory; and δ_{zx}⁶ indicates a straightness error of the X-axis in the direction of the Z-axis on the sixth trajectory;
substituting measured values into a left side of the formula (5) and corresponding coordinate values into a right side of the formula (5) to solve the six error terms to be solved;
rewriting the formula (6) into formula (7) in a matrix form, expressed by:
$$[ \begin{matrix}{δ}_{xx}^{1} \\ {δ}_{yx}^{2} \\ {δ}_{xx}^{3} \\ {δ}_{zx}^{4} \\ {δ}_{xx}^{5} \\ {δ}_{zx}^{6}\end{matrix} ] = [ \begin{matrix}1 & 0 & 0 & 0 & {z}_{1} & - {y}_{1} \\ 0 & 1 & 0 & - {z}_{2} & 0 & {x}_{2} \\ 0 & 0 & 1 & {y}_{3} & - {x}_{3} & 0 \\ 1 & 0 & 0 & 0 & {z}_{4} & - {y}_{4} \\ 0 & 1 & 0 & - {z}_{5} & 0 & {x}_{5} \\ 1 & 0 & 0 & 0 & {z}_{6} & - {y}_{6}\end{matrix} ] [ \begin{matrix}{δ}_{xx} \\ {δ}_{yx} \\ {δ}_{zx} \\ {ε}_{xx} \\ {ε}_{yx} \\ {ε}_{zx}\end{matrix} ] ; \qquad ( 7 )$$
and
δᵤᵥ represents a translation error of a v-axis in a direction of a u-axis, wherein the translation error comprises positioning error and straightness error; εᵤᵥ represents an angular error of the v-axis in the direction of the u-axis, wherein the u-axis is one of the X-axis, Y-axis, and Z-axis; and the v-axis is one of the X-axis, Y-axis, and Z-axis.
